(19) United States
(12) Patent Application Publication
(10) Pub. No.: US 2025/0371370 A1
(43) Pub. Date: Dec. 4, 2025

(54) INTERRUPTION AVOIDANCE DURING MODEL TRAINING WHEN USING FEDERATED LEARNING

(71) Applicant: Nokia Technologies Oy, Espoo (FI)

(72) Inventors: Prajwal KESHAVAMURTHY, Munich (DE); Tejas SUBRAMANYA, Munich (DE)

(21) Appl. No.: 18/997,425

(22) PCT Filed: Aug. 4, 2022
(86) PCT No.: PCT/EP2022/071993

§ 371 Date: Jan. 21, 2025

(51) Int. Cl. G06N 3/098

(52) U.S. Cl. CPC G06N 3/098

(57) ABSTRACT

An apparatus configured to train a model in a communications network using federated learning, the apparatus comprising means for: selecting at least two further apparatus for training a local model; further selecting a substitute apparatus for at least one of the at least two selected further apparatus; and configuring each of the at least two further apparatus for training the local model and configuring the substitute apparatus for the at least one of the two selected further apparatus for training the local model; receiving a local training result from at least one of the at least two further apparatus and a local training result from the substitute apparatus for the at least one of the two selected further apparatus; and combining the local training results to generate aggregated training results for the model.

### FIELD

The present application relates to a method, apparatus, system and computer program for performing training of a model using federated learning and in particular, but not exclusively to, a method, apparatus, system and computer program that avoids interruptions during training of a model using federated learning.

### BACKGROUND

A communication system can be seen as a facility that enables communications between two or more entities such as terminals, and/or other nodes, or provides connected services to entities. A communication system can include communication networks and one or more compatible terminals (otherwise known as communication devices). Communications may carry, for example, voice, video, electronic mail (email), text message, multimedia data and/or content data and so on. Non-limiting examples of connected services provided by the communications system may comprise enhanced mobile broadband, ultra-reliable low latency communications, mission-critical communications, massive internet of things (IoT), and multimedia services.

In a communication system at least a part of communications between at least two entities occurs over a wireless link. Examples of networks in a communication system are public land mobile networks (PLMN), radio access networks such as terrestrial radio access networks or non-terrestrial radio access networks (e.g., satellite networks) and different wireless local networks, for example wireless local area networks (WLAN). Radio access networks can include cells and are therefore often referred to as cellular networks.

A terminal may be referred to as user equipment (UE) or user device. A terminal is provided with an appropriate signal receiving and transmitting apparatus for enabling communications, for example enabling access to a communication network or communications directly with other terminals. The terminal may access a carrier provided by a base station, for example a base station of a radio access network, and transmit and/or receive communications on the carrier.

A communication system and associated compatible terminals typically operate in accordance with a given standard or specification which sets out what various network entities of the communication system are permitted to do and how that should be achieved. Communication protocols and/or parameters which shall be used for communications are also typically defined. One example of a communications system is a Universal Mobile Telecommunications System (UMTS) system (e.g., a communication system using 3G radio access technology). Other examples of communication systems are so call4G systems (e.g., communication systems operating using 4G radio access technology) and s5G or New Radio (NR) systems (e.g., communication systems operating using 5G or NR radio access technology). Radio access technologies that are used by communication systems are standardized by the 3rd Generation Partnership Project (3GPP).

### SUMMARY

According to an aspect, there is provided an apparatus configured to train a model in a communications network using federated learning, the apparatus comprising means for: selecting at least two further apparatus for training a local model; selecting a substitute apparatus for at least one of the at least two selected further apparatus; and configuring each of the at least two further apparatus for training the local model and configuring the substitute apparatus for the at least one of the two selected further apparatus for training the local model; receiving a local training result from at least one of the at least two further apparatus and a local training result from the substitute apparatus for the at least one of the two selected further apparatus; and combining the local training results to generate aggregated training results for the model.

The means for further selecting the substitute apparatus for at least one of the at least two selected further apparatus may be for selecting the substitute apparatus based on information indicating at least one of: a similarity in a data distribution of data of a local dataset for the at least one further apparatus and a data distribution of data of a local dataset for the substitute apparatus; a location of the further apparatus; a location of the substitute apparatus; a proximity between the further apparatus and the substitute apparatus; a mobility pattern of the substitute apparatus relative to the further apparatus; a quality of communications on the sidelink between the further apparatus and the substitute apparatus; at least one characteristic of a wireless link between the further apparatus and a base station of a radio access network.

The means may be for receiving from the at least one further apparatus information indicative of one or more candidate substitute apparatus, wherein the means for selecting the substitute apparatus for the at least one of the at least two selected further apparatus may be for selecting the substitute apparatus from the one or more candidate substitute apparatus identified by the further apparatus.

The means may be further for generating and sending a FL report configuration to each of the at least two further apparatuses, wherein the FL report configuration comprises an indicator caused to enable the at two further apparatus to generate a FL report comprising information identifying one or more potential substitute apparatus.

The means for configuring each of the at least two further apparatus for training the local model at the at least two further apparatus and configuring each substitute apparatus for training the local model at the substitute apparatus may be for generating a substitute training UE configuration for the at least one of the at least two further apparatus and the substitute apparatus, the substitute training UE configuration comprising at least one of: a further apparatus identifier configured to uniquely identify the at least one of the at least two further apparatus; a substitute apparatus identifier configured to uniquely identify the substitute further apparatus; a condition identifier configured to identify a condition where the at least one of the at least two further apparatus is unable to train the local model and which causes the substitute apparatus to perform local training model.

The condition may comprise at least one of: a minimum quality of a Uu link between the further apparatus and a base station of a radio access network; a minimum computation resource availability at the further apparatus; a minimum power resource availability at the further apparatus; and a minimum security/integrity level associated with a local dataset of the further apparatus.

The means for obtaining the local training results from the at least two further apparatus and when the at least one of the at least two further apparatus is unable to train the local model the apparatus may be further for receiving from the substitute apparatus an indicator caused to identify that the local training results trained local model is to be used as substitute for the local training results trained local models.

The means for configuring each of the at least two further apparatus for training the local model and configuring the substitute apparatus for the at least one of the two selected further apparatus for training the local model may be further for generating for the selected at least two further apparatus and the substitute apparatus a global model and training configuration, wherein the training of the local model is based on the global model and training configuration.

The means may be further for: receiving from the at least one of the at least two further apparatus an indication that the at least one of the at least two further apparatus is unable to train the local model; and generating a request for the substitute apparatus to perform local model training.

The request may comprise at least one of: an indicator of the cause of the at least one of the at least two further apparatus being unable to train the local model; and a time indicator indicating the time by which the substitute apparatus is to perform local model training.

The means for configuring each of the at least two further apparatus for training the local model and configuring the substitute apparatus for the at least one of the two selected further apparatus for training the local model may be further for: receiving an accept or reject substitute training UE configuration from the at least one of the at least two further apparatus; receiving an accept or reject substitute training UE configuration from the substitute apparatus; re-selecting and re-configuring, for the at least one of the at least two further apparatus, a further substitute apparatus based on receiving at least one reject substitute training configuration from the at least one of the at least two further apparatus or the substitute apparatus.

The apparatus may be one of: a base station of a radio access network, wherein the at least two further apparatus and the substitute apparatus are user equipment; a Network Data Analytics entity, wherein the at least two further apparatus and the substitute apparatus are distributed Network Data Analytics entities; and an Operations, Administration and Maintenance entity, wherein the at least two further apparatus and the substitute apparatus are base stations.

According to a second aspect there is provided an apparatus configured to train a local model during federated learning, the apparatus comprising means for: receiving substitute training UE configuration from a further apparatus configured to train a local model in a communications network comprising the apparatus, the substitute configuration comprising: an apparatus identifier configured to uniquely identify the apparatus for training the local model; a substitute apparatus identifier configured to uniquely identify a substitute apparatus for the apparatus; and a condition identifier configured to identify a condition where the apparatus is unable to train the local model and which causes the substitute apparatus to train the local model at the substitute apparatus; and training the local model and transmitting the local training result to the further apparatus, or determining the apparatus is unable to train the local model based on the condition where the apparatus is unable to train the local model and transmitting a local model training request to one of the further apparatus or the substitute apparatus to cause the substitute apparatus to perform local training at the substitute apparatus using a local dataset.

The means may be further for generating information indicating candidate substitute apparatus based on information indicating at least one of: a data distribution of the data in local datasets at the apparatus and a data distribution of the data in the local datasets at the candidate substitute apparatus; a spread/distribution of local data for the apparatus and the candidate substitute apparatus; a range of the data in local datasets at the apparatus and the candidate substitute apparatus; an interquartile range for the data in local datasets at the apparatus and the candidate substitute apparatus; a standard deviation for the data in local datasets at the apparatus and the candidate substitute apparatus; a variance of the data in local datasets at the apparatus and the candidate substitute apparatus; a proximity between the apparatus and the candidate substitute apparatus; and a mobility pattern between the apparatus and the candidate substitute apparatus.

The means may be further for receiving a request from the further apparatus to generate the information indicating candidate substitute apparatus.

The at least one condition may comprise at least one of: a minimum quality of a Uu link between the apparatus and a base station of a radio access network; a minimum computation resource availability at the apparatus; a minimum power resource availability at the apparatus; and a minimum security/integrity level associated with a local dataset of the further apparatus.

The local model training request may comprise: an indicator identifying the condition causing the apparatus to be unable to train the local model; and a time indicator indicating the time by which the substitute apparatus is to train a local model.

The means may be further for generating an accept or reject substitute training UE configuration to the further apparatus, wherein the further apparatus may be caused to re-select and re-configure, for the apparatus, a further substitute apparatus.

The apparatus may be a user equipment, wherein the substitute apparatus may be a user equipment and the further apparatus may be a base station of a radio access network.

The apparatus may be a wireless communications device, wherein the substitute apparatus may be a wireless communications device and the further apparatus may be a base station of a radio access network.

The apparatus may be a distributed network data analytics entity, wherein the further apparatus may be a centralized Network Data Analytics entity and the substitute apparatus may be a distributed Network Data Analytics entity.

The apparatus may be a base station of a radio access network, wherein the further apparatus may be an Operations, Administration and Maintenance entity, and the substitute apparatus may be a base station of a radio access network.

The apparatus may be an open radio access network function, wherein the further apparatus may be an open radio access network function and the substitute apparatus may be an open radio access network function.

According to a third aspect there is provided an apparatus configured to train a local model for federated learning, the apparatus comprising means for: receiving substitute training UE configuration from a further apparatus configured to train a local model in a communications network comprising the apparatus, the substitute configuration comprising: an apparatus identifier configured to uniquely identify another apparatus as an apparatus for training the local model using a local dataset; a substitute apparatus identifier configured to uniquely identify the apparatus as a substitute training apparatus for the another apparatus; and a condition identifier configured to identify a condition where the another apparatus is unable to train the local model and which causes the apparatus to train the local model at the apparatus; and receiving a local model training request from the another apparatus or the further apparatus to train the local model when the another apparatus is unable to train the local model; training the local model using a local dataset and transmitting a training result to the further apparatus after receiving the request.

The local model training request may comprise at least one of: an indicator identifying the condition causing the another apparatus to be unable to train the local model; and a time indicator indicating the time by which the apparatus is to train the local model.

The means may be further for generating an accept or reject message to the further apparatus, wherein the further apparatus may be caused to re-select and re-configure, for the another apparatus, a further substitute apparatus.

The means for training the local model and transmitting the trained local model to the further apparatus after receiving the request may be further for transmitting an indicator to identify that the updates for parameters of the trained local model is to be used as substitute updates for parameters of the trained local model.

The apparatus may be a user equipment, wherein the another apparatus may be a user equipment and the further apparatus may be a base station of a radio access network.

The apparatus may be a wireless communications device, wherein the another apparatus may be a wireless communications device and the further apparatus may be a base station of a radio access network The apparatus may be a distributed network data analytics entity, wherein the further apparatus may be a centralized Network Data Analytics entity and the another apparatus may be a distributed Network Data Analytics entity.

The apparatus may be a base station of a radio access network, wherein the further apparatus may be an Operations, Administration and Maintenance entity, and the another apparatus may be a base station of a radio access network.

The apparatus may be an open radio access network entity, wherein the further apparatus may be an open radio access network entity and the another apparatus may be an open radio access network entity.

According to a fourth aspect there is provided a method for an apparatus configured to train a model in a communications network using federated learning, the method comprising: selecting at least two further apparatus for training a local model; selecting a substitute apparatus for at least one of the at least two selected further apparatus; and configuring each of the at least two further apparatus for training the local model and configuring the substitute apparatus for the at least one of the two selected further apparatus for training the local model; receiving a local training result from at least one of the at least two further apparatus and a local training result from the substitute apparatus for the at least one of the two selected further apparatus; and combining the local training results to generate aggregated training results for the model.

Selecting the substitute apparatus for at least one of the at least two selected further apparatus may comprise selecting the substitute apparatus based on information indicating at least one of: a similarity in a data distribution of data of a local dataset for the at least one further apparatus and a data distribution of data of a local dataset for the substitute apparatus; a location of the further apparatus; a location of the substitute apparatus; a proximity between the further apparatus and the substitute apparatus; a mobility pattern of the substitute apparatus relative to the further apparatus; a quality of communications on the sidelink between the further apparatus and the substitute apparatus; at least one characteristic of a Uu link between the further apparatus and a base station of a radio access network.

The method may comprise receiving from the at least one further apparatus information indicative of one or more potential substitute apparatus, wherein selecting the substitute apparatus for the at least one of the at least two selected further apparatus may comprise selecting the substitute apparatus from the potential substitute apparatus identified by the further apparatus.

The method may further comprise generating and sending a FL report configuration to each of the at least two further apparatuses, wherein the FL report configuration comprises an indicator caused to enable the at two further apparatus to generate a FL report comprising information identifying one or more potential substitute apparatus.

Configuring each of the at least two further apparatus for training the local model at the at least two further apparatus and configuring each substitute apparatus for training the local model at the substitute apparatus may comprise generating a substitute training UE configuration for the at least one of the at least two further apparatus and the substitute apparatus, the substitute training UE configuration comprising at least one of: a further apparatus identifier configured to uniquely identify the at least one of the at least two further apparatus; a substitute apparatus identifier configured to uniquely identify the substitute further apparatus; a condition identifier configured to identify a condition where the at least one of the at least two further apparatus is unable to train the local model and which causes the substitute apparatus to train the local model at the substitute apparatus.

The condition may comprise at least one of: a minimum quality of a Uu link between the further apparatus and a base station of a radio access network; a minimum computation resource availability at the further apparatus; a minimum power resource availability at the further apparatus; and a minimum security/integrity level associated with a local dataset of the further apparatus.

Obtaining the local training results from the at least two further apparatus and when the at least one of the at least two further apparatus is unable to train the local model may comprise receiving from the substitute apparatus an indicator caused to identify that the local training results trained local model is to be used as substitute for the local training results trained local models.

Configuring each of the at least two further apparatus for training the local model and configuring the substitute apparatus for the at least one of the two selected further apparatus for training the local model may further comprise generating for the selected at least two further apparatus and the substitute apparatus a global model and training configuration, wherein the training of the local model is based on the global model and training configuration.

The method may further comprise: receiving from the at least one of the at least two further apparatus an indication that the at least one of the at least two further apparatus is unable to train the local model; and generating a request for the substitute apparatus to cause training the local model at the substitute apparatus.

The request may comprise at least one of: an indicator of the cause of the at least one of the at least two further apparatus being unable to train the local model; and a time indicator indicating the time by which the substitute apparatus is to train the local model at the substitute apparatus.

Configuring each of the at least two further apparatus for training the local model and configuring the substitute apparatus for the at least one of the two selected further apparatus for training the local model may further comprise: receiving an accept or reject substitute training UE configuration from the at least one of the at least two further apparatus; receiving an accept or reject substitute training UE configuration from the substitute apparatus; re-selecting and re-configuring, for the at least one of the at least two further apparatus, a further substitute apparatus based on receiving at least one reject substitute training UE configuration from the at least one of the at least two further apparatus or the substitute apparatus.

The apparatus may be one of: a base station of a radio access network, wherein the at least two further apparatus and the substitute apparatus are user equipment; a Network Data Analytics entity, wherein the at least two further apparatus and the substitute apparatus are distributed Network Data Analytics entities; and an Operations, Administration and Maintenance entity, wherein the at least two further apparatus and the substitute apparatus are base stations.

The apparatus may be an open radio access network application function, wherein the at least two further apparatus and the substitute apparatus are open radio access network applications.

According to a fifth aspect there is provided a method for an apparatus configured to train a local model during federated learning, the method comprising: receiving substitute training UE configuration from a further apparatus configured to train a local model in a communications network comprising the apparatus, the substitute configuration comprising: an apparatus identifier configured to uniquely identify the apparatus for training the local model; a substitute apparatus identifier configured to uniquely identify a substitute apparatus for the apparatus; and a condition identifier configured to identify a condition where the apparatus is unable to train the local model and which causes the substitute apparatus to train the local model at the substitute apparatus; and training the local model and transmitting the local training result to the further apparatus, or determining the apparatus is unable to train the local model based on the condition where the apparatus is unable to train the local model and transmitting a local model training request to one of the further apparatus or the substitute apparatus to cause the substitute apparatus to perform local training at the substitute apparatus using a local dataset.

The method may further comprise generating information indicating candidate substitute apparatus based on information indicating at least one of: a data distribution of the data in local datasets at the apparatus and a data distribution of the data in the local datasets at the candidate substitute apparatus; a spread/distribution of local data for the apparatus and the candidate substitute apparatus; a range of the data in local datasets at the apparatus and the candidate substitute apparatus; an interquartile range for the data in local datasets at the apparatus and the candidate substitute apparatus; a standard deviation for the data in local datasets at the apparatus and the candidate substitute apparatus; a variance of the data in local datasets at the apparatus and the candidate substitute apparatus; a proximity between the apparatus and the candidate substitute apparatus; and a mobility pattern between the apparatus and the candidate substitute apparatus.

The method may further comprise receiving a request from the further apparatus to generate the information indicating candidate substitute apparatus.

The at least one condition may comprise at least one of: a minimum quality of a Uu link between the apparatus and a base station of a radio access network; a minimum computation resource availability at the apparatus; a minimum power resource availability at the apparatus; and a minimum security/integrity level associated with a local dataset of the further apparatus.

The local model training request may comprise: an indicator identifying the condition causing the apparatus to be unable to train the local model; and a time indicator indicating the time by which the substitute apparatus is to train a local model.

The method may further comprise generating an accept or reject substitute training UE configuration to the further apparatus, wherein the further apparatus may be caused to re-select and re-configure, for the apparatus, a further substitute apparatus.

The apparatus may be a user equipment, wherein the substitute apparatus may be a user equipment and the further apparatus may be a base station of a radio access network.

The apparatus may be a wireless communications device, wherein the substitute apparatus may be a wireless communications device and the further apparatus may be a base station of a radio access network.

The apparatus may be a distributed network data analytics entity, wherein the further apparatus may be a centralized Network Data Analytics entity and the substitute apparatus may be a distributed Network Data Analytics entity.

The apparatus may be a base station of a radio access network, wherein the further apparatus may be an Operations, Administration and Maintenance entity, and the substitute apparatus may be a base station of a radio access network.

The apparatus may be an open radio access network function, wherein the further apparatus may be an open radio access network function and the substitute apparatus may be an open radio access network function.

According to a sixth aspect there is provided a method for an apparatus configured to train a local model for federated learning, the method comprising: receiving substitute training UE configuration from a further apparatus configured to train a local model in a communications network comprising the apparatus, the substitute configuration comprising: an apparatus identifier configured to uniquely identify another apparatus as an apparatus for training the local model using a local dataset; a substitute apparatus identifier configured to uniquely identify the apparatus as a substitute training apparatus for the another apparatus; and a condition identifier configured to identify a condition where the another apparatus is unable to train the local model and which causes the apparatus to train the local model at the apparatus; and receiving a local model training request from the another apparatus or the further apparatus to train the local model when the another apparatus is unable to train the local model; training the local model using a local dataset and transmitting a training result to the further apparatus after receiving the request.

The local model training request may comprise at least one of: an indicator identifying the condition causing the another apparatus to be unable to train the local model; and a time indicator indicating the time by which the apparatus is to train the local model.

The method may further comprise generating an accept message or reject message to the further apparatus, wherein the further apparatus may be caused to re-select and re-configure, for the another apparatus, a further substitute apparatus.

Training the local model and transmitting the trained local model to the further apparatus after receiving the request may comprise transmitting an indicator to identify that the updates for parameters of the trained local model is to be used as substitute updates for parameters of the trained local model.

The apparatus may be a user equipment, wherein the another apparatus may be a user equipment and the further apparatus may be a base station of a radio access network.

The apparatus may be a wireless communications device, wherein the another apparatus may be a wireless communications device and the further apparatus may be a base station of a radio access network The apparatus may be a distributed network data analytics entity, wherein the further apparatus may be a centralized Network Data Analytics entity and the another apparatus may be a distributed Network Data Analytics entity.

The apparatus may be a base station of a radio access network, wherein the further apparatus may be an Operations, Administration and Maintenance entity, and the another apparatus may be a base station of a radio access network.

The apparatus may be an open radio access network entity, wherein the further apparatus may be an open radio access network entity and the another apparatus may be an open radio access network entity.

According to a seventh aspect there is provided an apparatus, configured to train a model in a communications network using federated learning, comprising: at least one processor and at least one memory storing instructions that, when executed by the at least one processor, cause the apparatus at least to: select at least two further apparatus for training a local model; select a substitute apparatus for at least one of the at least two selected further apparatus; and configure each of the at least two further apparatus for training the local model and configure the substitute apparatus for the at least one of the two selected further apparatus for training the local model; receive a local training result from at least one of the at least two further apparatus and a local training result from the substitute apparatus for the at least one of the two selected further apparatus; and combine the local training results to generate aggregated training results for the model.

The apparatus caused to select the substitute apparatus for at least one of the at least two selected further apparatus may be further caused to select the substitute apparatus based on information indicating at least one of: a similarity in a data distribution of data of a local dataset for the at least one further apparatus and a data distribution of data of a local dataset for the substitute apparatus; a location of the further apparatus; a location of the substitute apparatus; a proximity between the further apparatus and the substitute apparatus; a mobility pattern of the substitute apparatus relative to the further apparatus; a quality of communications on the sidelink between the further apparatus and the substitute apparatus; at least one characteristic of a Uu link between the further apparatus and a base station of a radio access network.

The apparatus may be further caused to receive from the at least one further apparatus information indicative of one or more potential substitute apparatus, wherein the apparatus caused to select the substitute apparatus for the at least one of the at least two selected further apparatus may be caused to select the substitute apparatus from the potential substitute apparatus identified by the further apparatus.

The apparatus may be further caused to generate and send a FL report configuration to each of the at least two further apparatuses, wherein the FL report configuration comprises an indicator caused to enable the at two further apparatus to generate a FL report comprising information identifying one or more potential substitute apparatus.

The apparatus caused to configure each of the at least two further apparatus for training the local model at the at least two further apparatus and configure each substitute apparatus for training the local model at the substitute apparatus may be caused to generate a substitute training configuration for the at least one of the at least two further apparatus and the substitute apparatus, the substitute training configuration comprising at least one of: a further apparatus identifier configured to uniquely identify the at least one of the at least two further apparatus; a substitute apparatus identifier configured to uniquely identify the substitute further apparatus; a condition identifier configured to identify a condition where the at least one of the at least two further apparatus is unable to train the local model and which causes the substitute apparatus to train the local model at the substitute apparatus.

The condition may comprise at least one of: a minimum quality of a Uu link between the further apparatus and a base station of a radio access network; a minimum computation resource availability at the further apparatus; a minimum power resource availability at the further apparatus; and a minimum security/integrity level associated with a local dataset of the further apparatus.

The apparatus caused to obtain the local training results from the at least two further apparatus and when the at least one of the at least two further apparatus is unable to train the local model the apparatus may be further caused to receive from the substitute apparatus an indicator caused to identify that the local training results trained local model is to be used as substitute for the local training results trained local models.

The apparatus caused to configure each of the at least two further apparatus for training the local model and configuring the substitute apparatus for the at least one of the two selected further apparatus for training the local model may be further caused to generate for the selected at least two further apparatus and the substitute apparatus a global model and training configuration, wherein the training of the local model is based on the global model and training configuration.

The apparatus may be further caused to: receive from the at least one of the at least two further apparatus an indication that the at least one of the at least two further apparatus is unable to train the local model; and generate a request for the substitute apparatus to cause training the local model at the substitute apparatus.

The request may comprise at least one of: an indicator of the cause of the at least one of the at least two further apparatus being unable to train the local model; and a time indicator indicating the time by which the substitute apparatus is to train the local model at the substitute apparatus.

The apparatus caused to configure each of the at least two further apparatus for training the local model and configuring the substitute apparatus for the at least one of the two selected further apparatus for training the local model may be further caused to: receive an accept or reject substitute training configuration from the at least one of the at least two further apparatus; receive an accept or reject substitute training configuration from the substitute apparatus; re-select and re-configure, for the at least one of the at least two further apparatus, a further substitute apparatus based on receiving at least one reject substitute training configuration from the at least one of the at least two further apparatus or the substitute apparatus.

The apparatus may be one of: a base station of a radio access network, wherein the at least two further apparatus and the substitute apparatus are user equipment; a Network Data Analytics entity, wherein the at least two further apparatus and the substitute apparatus are distributed Network Data Analytics entities; and an Operations, Administration and Maintenance entity, wherein the at least two further apparatus and the substitute apparatus are base stations.

The apparatus may be an open radio access network application function, wherein the at least two further apparatus and the substitute apparatus are open radio access network applications.

According to a eighth aspect there is provided an apparatus configured to train a local model during federated learning, the apparatus comprising: at least one processor and at least one memory storing instructions that, when executed by the at least one processor, cause the apparatus at least to receive substitute training configuration from a further apparatus configured to train a local model in a communications network comprising the apparatus, the substitute configuration comprising: an apparatus identifier configured to uniquely identify the apparatus for training the local model; a substitute apparatus identifier configured to uniquely identify a substitute apparatus for the apparatus; and a condition identifier configured to identify a condition where the apparatus is unable to train the local model and which causes the substitute apparatus to train the local model at the substitute apparatus; and train the local model and transmit the local training result to the further apparatus, or determine the apparatus is unable to train the local model based on the condition where the apparatus is unable to train the local model and transmitting a local model training request to one of the further apparatus or the substitute apparatus to cause the substitute apparatus to perform local training at the substitute apparatus using a local dataset.

The apparatus may be further caused to generate information indicating candidate substitute apparatus based on information indicating at least one of: a data distribution of the data in local datasets at the apparatus and a data distribution of the data in the local datasets at the candidate substitute apparatus; a spread/distribution of local data for the apparatus and the candidate substitute apparatus; a range of the data in local datasets at the apparatus and the candidate substitute apparatus; an interquartile range for the data in local datasets at the apparatus and the candidate substitute apparatus; a standard deviation for the data in local datasets at the apparatus and the candidate substitute apparatus; a variance of the data in local datasets at the apparatus and the candidate substitute apparatus; a proximity between the apparatus and the candidate substitute apparatus; and a mobility pattern between the apparatus and the candidate substitute apparatus.

The apparatus may be further caused to receive a request from the further apparatus to generate the information indicating candidate substitute apparatus.

The at least one condition may comprise at least one of: a minimum quality of a Uu link between the apparatus and a base station of a radio access network; a minimum computation resource availability at the apparatus; a minimum power resource availability at the apparatus; and a minimum security/integrity level associated with a local dataset of the further apparatus.

The local model training request may comprise: an indicator identifying the condition causing the apparatus to be unable to train the local model; and a time indicator indicating the time by which the substitute apparatus is to train a local model.

The apparatus may be further caused to generate an accept or reject substitute training configuration to the further apparatus, wherein the further apparatus may be caused to re-select and re-configure, for the apparatus, a further substitute apparatus.

The apparatus may be a user equipment, wherein the substitute apparatus may be a user equipment and the further apparatus may be a base station of a radio access network.

The apparatus may be a wireless communications device, wherein the substitute apparatus may be a wireless communications device and the further apparatus may be a base station of a radio access network.

The apparatus may be a distributed network data analytics entity, wherein the further apparatus may be a centralized Network Data Analytics entity and the substitute apparatus may be a distributed Network Data Analytics entity.

The apparatus may be a base station of a radio access network, wherein the further apparatus may be an Operations, Administration and Maintenance entity, and the substitute apparatus may be a base station of a radio access network.

The apparatus may be an open radio access network function, wherein the further apparatus may be an open radio access network function and the substitute apparatus may be an open radio access network function.

According to a ninth aspect there is provided an apparatus configured to train a local model for federated learning, the apparatus comprising: at least one processor and at least one memory storing instructions that, when executed by the at least one processor, cause the apparatus at least to: receive substitute training configuration from a further apparatus configured to train a local model in a communications network comprising the apparatus, the substitute configuration comprising: an apparatus identifier configured to uniquely identify another apparatus as an apparatus for training the local model using a local dataset; a substitute apparatus identifier configured to uniquely identify the apparatus as a substitute training apparatus for the another apparatus; and a condition identifier configured to identify a condition where the another apparatus is unable to train the local model and which causes the apparatus to train the local model at the apparatus; and receive a local model training request from the another apparatus or the further apparatus to train the local model when the another apparatus is unable to train the local model; train the local model using a local dataset and transmit a training result to the further apparatus after receiving the request.

The local model training request may comprise at least one of: an indicator identifying the condition causing the another apparatus to be unable to train the local model; and a time indicator indicating the time by which the apparatus is to train the local model.

The apparatus may be further caused to generate an accept or reject substitute training configuration message to the further apparatus, wherein the further apparatus may be caused to re-select and re-configure, for the another apparatus, a further substitute apparatus.

The apparatus caused to train the local model and transmit the trained local model to the further apparatus after receiving the request may be further caused to transmit an indicator to identify that the updates for parameters of the trained local model is to be used as substitute updates for parameters of the trained local model.

The apparatus may be a user equipment, wherein the another apparatus may be a user equipment and the further apparatus may be a base station of a radio access network.

The apparatus may be a wireless communications device, wherein the another apparatus may be a wireless communications device and the further apparatus may be a base station of a radio access network The apparatus may be a distributed network data analytics entity, wherein the further apparatus may be a centralized Network Data Analytics entity and the another apparatus may be a distributed Network Data Analytics entity.

The apparatus may be a base station of a radio access network, wherein the further apparatus may be an Operations, Administration and Maintenance entity, and the another apparatus may be a base station of a radio access network.

The apparatus may be an open radio access network entity, wherein the further apparatus may be an open radio access network entity and the another apparatus may be an open radio access network entity.

According to a tenth aspect there is provided an apparatus configured to train a model in a communications network using federated learning, the apparatus comprising: means for selecting at least two further apparatus for training a local model; means for selecting a substitute apparatus for at least one of the at least two selected further apparatus; and means for configuring each of the at least two further apparatus for training the local model and configuring the substitute apparatus for the at least one of the two selected further apparatus for training the local model; means for receiving a local training result from at least one of the at least two further apparatus and a local training result from the substitute apparatus for the at least one of the two selected further apparatus; and means for combining the local training results to generate aggregated training results for the model.

According to an eleventh aspect there is provided an apparatus, apparatus configured to train a local model during federated learning, comprising: means for receiving substitute training configuration from a further apparatus configured to train a local model in a communications network comprising the apparatus, the substitute configuration comprising: an apparatus identifier configured to uniquely identify the apparatus for training the local model; a substitute apparatus identifier configured to uniquely identify a substitute apparatus for the apparatus; and a condition identifier configured to identify a trigger condition where the apparatus is unable to train the local model and which causes the substitute apparatus to perform local model training; and means for training the local model and transmitting the local training result to the further apparatus, or determining the apparatus is unable to train the local model based on the condition where the apparatus is unable to train the local model and transmitting a local model training request to one of the further apparatus or the substitute apparatus to cause the substitute apparatus to perform local model training.

According to a twelfth aspect there is provided an apparatus, configured to train a local model for federated learning, comprising: means for: receiving substitute training configuration from a further apparatus configured to train a local model in a communications network comprising the apparatus, the substitute configuration comprising: an apparatus identifier configured to uniquely identify another apparatus as an apparatus for training the local model using a local dataset; a substitute apparatus identifier configured to uniquely identify the apparatus as a substitute training apparatus for the another apparatus; and a condition identifier configured to identify a condition where the another apparatus is unable to train the local model and which causes the apparatus to train the local model at the apparatus; and means for receiving a local model training request from the another apparatus or the further apparatus to train the local model when the another apparatus is unable to train the local model; means for training the local model using a local dataset and transmitting a local training result to the further apparatus after receiving the request.

According to a thirteenth aspect there is provided a computer program comprising instructions [or a computer readable medium comprising program instructions] for causing an apparatus, configured to train a model in a communications network using federated learning, to perform at least the following: selecting at least two further apparatus for training a local model; selecting a substitute apparatus for at least one of the at least two selected further apparatus; and configuring each of the at least two further apparatus for training the local model and configuring the substitute apparatus for the at least one of the two selected further apparatus for training the local model; receiving a local training result from at least one of the at least two further apparatus and a local training result from the substitute apparatus for the at least one of the two selected further apparatus; and combining the local training results to generate aggregated training results for the model.

According to a fourteenth aspect there is provided a computer program comprising instructions [or a computer readable medium comprising program instructions] for causing an apparatus, configured to train a local model during federated learning to perform at least the following: receiving substitute training configuration from a further apparatus configured to train a local model in a communications network comprising the apparatus, the substitute configuration comprising: an apparatus identifier configured to uniquely identify the apparatus for training the local model; a substitute apparatus identifier configured to uniquely identify a substitute apparatus for the apparatus; and a condition identifier configured to identify a condition where the apparatus is unable to train the local model and which causes the substitute apparatus to train the local model at the substitute apparatus; and training the local model and transmitting the local training result to the further apparatus, or determining the apparatus is unable to train the local model based on the condition where the apparatus is unable to train the local model and transmitting a local model training request to one of the further apparatus or the substitute apparatus to cause the substitute apparatus to perform local training at the substitute apparatus using a local dataset.

According to a fifteenth aspect there is provided a computer program comprising instructions [or a computer readable medium comprising program instructions] for causing an apparatus, configured to train a local model for federated learning, to perform at least the following: receiving substitute training UE configuration from a further apparatus configured to train a local model in a communications network comprising the apparatus, the substitute configuration comprising: an apparatus identifier configured to uniquely identify another apparatus as an apparatus for training the local model using a local dataset; a substitute apparatus identifier configured to uniquely identify the apparatus as a substitute training apparatus for the another apparatus; and a condition identifier configured to identify a condition where the another apparatus is unable to train the local model and which causes the apparatus to train the local model at the apparatus; and receiving a local model training request from the another apparatus or the further apparatus to train the local model when the another apparatus is unable to train the local model; training the local model using a local dataset and transmitting a local training result to the further apparatus after receiving the request.

According to a sixteenth aspect there is provided a non-transitory computer readable medium comprising program instructions for causing an apparatus, configured to train a model in a communications network using federated learning, to perform at least the following: selecting at least two further apparatus for training a local model; selecting a substitute apparatus for at least one of the at least two selected further apparatus; and configuring each of the at least two further apparatus for training the local model and configuring the substitute apparatus for the at least one of the two selected further apparatus for training the local model; receiving a local training result from at least one of the at least two further apparatus and a local training result from the substitute apparatus for the at least one of the two selected further apparatus; and combining the local training results to generate aggregated training results for the model.

According to a seventeenth aspect there is provided a non-transitory computer readable medium comprising program instructions for causing an apparatus, configured to train a local model during federated learning, to perform at least the following: receiving substitute training configuration from a further apparatus configured to train a local model in a communications network comprising the apparatus, the substitute configuration comprising: an apparatus identifier configured to uniquely identify the apparatus for training the local model; a substitute apparatus identifier configured to uniquely identify a substitute apparatus for the apparatus; and a condition identifier configured to identify a condition where the apparatus is unable to train the local model and which causes the substitute apparatus to train the local model at the substitute apparatus; and training the local model and transmitting the local training result to the further apparatus, or determining the apparatus is unable to train the local model based on the condition where the apparatus is unable to train the local model and transmitting a local model training request to one of the further apparatus or the substitute apparatus to cause the substitute apparatus to perform local training at the substitute apparatus using a local dataset.

According to an eighteenth aspect there is provided a non-transitory computer readable medium comprising program instructions for causing an apparatus, configured to train a local model for federated learning, to perform at least the following: receiving substitute training configuration from a further apparatus configured to train a local model in a communications network comprising the apparatus, the substitute configuration comprising: an apparatus identifier configured to uniquely identify another apparatus as an apparatus for training the local model using a local dataset; a substitute apparatus identifier configured to uniquely identify the apparatus as a substitute training apparatus for the another apparatus; and a condition identifier configured to identify a condition where the another apparatus is unable to train the local model and which causes the apparatus to train the local model at the apparatus; and receiving a local model training request from the another apparatus or the further apparatus to train the local model when the another apparatus is unable to train the local model; training the local model using a local dataset and transmitting a local training result to the further apparatus after receiving the request.

According to a nineteenth aspect there is provided an apparatus, configured to train a model in a communications network using federated learning, comprising: selecting circuitry configured to select at least two further apparatus for training a local model; selecting circuitry configured to select a substitute apparatus for at least one of the at least two selected further apparatus; and configuring circuitry configured to configure each of the at least two further apparatus for training the local model and to configure the substitute apparatus for the at least one of the two selected further apparatus for training the local model; receiving circuitry configured to receive a local training result from at least one of the at least two further apparatus and a local training result from the substitute apparatus for the at least one of the two selected further apparatus; and combining circuitry configured to combine the local training results to generate aggregated training results for the model.

According to a twentieth aspect there is provided an apparatus, configured to train a local model during federated learning, comprising: receiving circuitry configured to receive substitute training configuration from a further apparatus configured to train a local model in a communications network comprising the apparatus, the substitute configuration comprising: an apparatus identifier configured to uniquely identify the apparatus for training the local model; a substitute apparatus identifier configured to uniquely identify a substitute apparatus for the apparatus; and a condition identifier configured to identify a condition where the apparatus is unable to train the local model and which causes the substitute apparatus to train the local model at the substitute apparatus; training circuitry configured to train the local model; control circuitry configured to control transmitting the local training result to the further apparatus; determining circuitry configured to determine the apparatus is unable to train the local model based on the condition where the apparatus is unable to train the local model and control circuitry configured to control transmitting a local model training request to one of the further apparatus or the substitute apparatus to cause the substitute apparatus to perform local model training at the substitute apparatus using a local dataset.

According to a twenty-first aspect there is provided an apparatus, configured to train a local model for federated learning, comprising: receiving circuitry configured to receive substitute training configuration from a further apparatus configured to train a local model in a communications network comprising the apparatus, the substitute configuration comprising: an apparatus identifier configured to uniquely identify another apparatus as an apparatus for training the local model using a local dataset; a substitute apparatus identifier configured to uniquely identify the apparatus as a substitute training apparatus for the another apparatus; and a condition identifier configured to identify a condition where the another apparatus is unable to train the local model and which causes the apparatus to train the local model at the apparatus; and receiving circuitry configured to receive a local model training request from the another apparatus or the further apparatus to train the local model when the another apparatus is unable to train the local model; training circuitry configured to train the local model using a local dataset; and controlling circuitry configured to control transmitting a local training result to the further apparatus after receiving the local model training request.

According to a twenty-second aspect there is provided a computer readable medium comprising program instructions for causing an apparatus, configured to train a model in a communications network using federated learning, to perform at least the following: selecting at least two further apparatus for training a local model; selecting a substitute apparatus for at least one of the at least two selected further apparatus; and configuring each of the at least two further apparatus for training the local model and configuring the substitute apparatus for the at least one of the two selected further apparatus for training the local model; receiving a local training result from at least one of the at least two further apparatus and a local training result from the substitute apparatus for the at least one of the two selected further apparatus; and combining the local training results to generate aggregated training results for the model.

According to a twenty-third aspect there is provided a computer readable medium comprising program instructions for causing an apparatus, configured to train a local model during federated learning, to perform at least the following: receiving substitute training configuration from a further apparatus configured to train a local model in a communications network comprising the apparatus, the substitute configuration comprising: an apparatus identifier configured to uniquely identify the apparatus for training the local model; a substitute apparatus identifier configured to uniquely identify a substitute apparatus for the apparatus; and a condition identifier configured to identify a condition where the apparatus is unable to train the local model and which causes the substitute apparatus to train the local model at the substitute apparatus; and training the local model and transmitting the local training result to the further apparatus, or determining the apparatus is unable to train the local model based on the condition where the apparatus is unable to train the local model and transmitting a local training model request to one of the further apparatus or the substitute apparatus to cause the substitute apparatus to perform local training at the substitute apparatus using a local dataset.

According to a twenty-fourth aspect there is provided a computer readable medium comprising program instructions for causing an apparatus, configured to train a local model for federated learning, to perform the following: receiving substitute training configuration from a further apparatus configured to train a local model in a communications network comprising the apparatus, the substitute configuration comprising: an apparatus identifier configured to uniquely identify another apparatus as an apparatus for training the local model using a local dataset; a substitute apparatus identifier configured to uniquely identify the apparatus as a substitute training apparatus for the another apparatus; and a condition identifier configured to identify a condition where the another apparatus is unable to train the local model and which causes the apparatus to train the local model at the apparatus; and receiving a local model training request from the another apparatus or the further apparatus to train the local model when the another apparatus is unable to train the local model; training the local model using a local dataset and transmitting a training result to the further apparatus after receiving the request.

An apparatus comprising means for performing the actions of the method as described above.

An apparatus configured to perform the actions of the method as described above.

A computer program comprising program instructions for causing a computer to perform the method as described above.

A computer program product stored on a medium may cause an apparatus to perform the method as described herein.

According to an aspect, there is provided a non-transitory computer readable medium comprising program instructions for causing an apparatus to perform at least the method according to any of the preceding aspects.

In the above, many different embodiments have been described. It should be appreciated that further embodiments may be provided by the combination of any two or more of the embodiments described above.

### DESCRIPTION OF FIGURES

Embodiments will now be described, by way of example only, with reference to the accompanying Figures in which:

FIG. 1 shows a representation of a network system according to some example embodiments;

FIG. 2 shows a representation of a control apparatus according to some example embodiments;

FIG. 3 shows a representation of an apparatus according to some example embodiments;

FIG. 4 shows a flow diagram of an example of training a model using federated learning (FL); and

FIGS. 5 to 7 show flow diagrams of examples of interruption avoidance during the training of models using federated learning (FL) according to some example embodiments.

### DETAILED DESCRIPTION

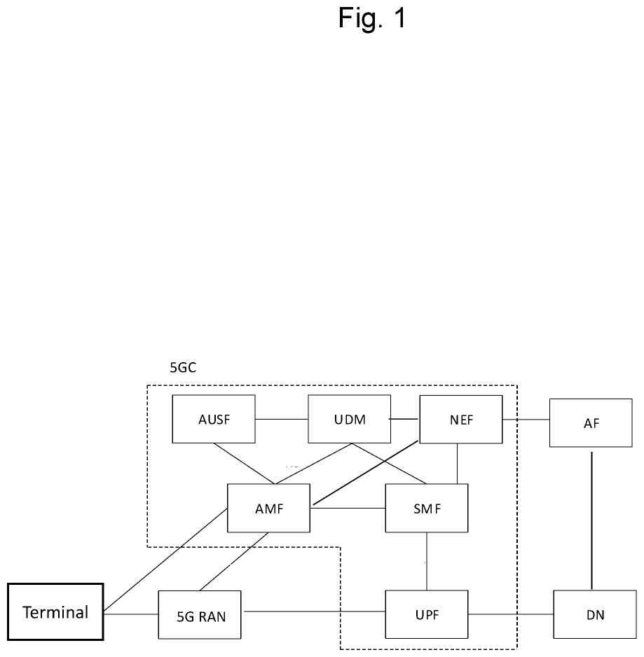

In the following certain embodiments are explained with reference to apparatuses capable of communication with a communication system serving such apparatuses. Before explaining in detail the exemplifying embodiments, certain general principles of a communication system, for example a 5G communication system, that includes an access network (AN) and a core network, and apparatuses (e.g., terminals served by the communication system are briefly explained with reference to FIGS. 1, 2 and 3 to assist in understanding the technology underlying the described examples.

FIG. 1 shows a schematic representation of a 5G wireless communication system (5GS). The 5GS may be comprised of a radio access network (RAN) (e.g., a 5G radio access network (5G-RAN) or a next generation radio access network (NG-RAN), a 5G core network (5GC), one or more application functions (AFs) and a more data network (DN). In some embodiments, an AF is a customer of the 5GC and is connected to a user plane function (UPF) of the 5GC via the DN and to network functions (NFs) of the 5GC via a network exposure function (NEF) of the 5GC. In some embodiments, the AF is a trusted application function and hence the trusted AF is implemented in the 5GC and connected to directly to other NFs of the 5GC. The AF may include functionality to perform training using federated learning and to select terminals connected to the 5GC that participate in FL as described in further detail below. It will be appreciated that although only one UPF is shown in FIG. 1, the 5GS may be composed of a chain of UFPs that include a UPF anchor that connects to the DN. The connections between the AF and the NEF and the UPF (or the AF and the NFs of the 5GC, are via interfaces defined in the 3GPP standard.

The 5GC may comprise for instance the following network functions (NFs) (otherwise referred to as network entities): Network Slice Selection Function (NSSF); Network Exposure Function (NEF); Network Repository Function (NRF); Network Data Analytics Function (NWDAF), Policy Control Function (PCF); Unified Data Management (UDM); Authentication Server Function (AUSF); an Access and Mobility Management Function (AMF); and Session Management Function (SMF). The NFs of the 5GC may have a service-based architecture as described in TR 23.501 of the 3GPP standard. NF services that may be offered by the NFs of the 5GC and service-based interfaces for the NFs of the 5GC are described in 3GPP standard, and in particular in TR 23.501 and 23.502 of the 3GPP standard.

Access to the 5GC by terminals may be done more generally via an access network, such as a 5G radio access network (5G-RAN). The 5G-RAN may comprise one or more base stations (e.g., gNodeBs (gNBs)). The gNBs of the 5G-RAN may include a gNB distributed unit connected to a gNB central unit, and remote radio heads connected to the gNB distributed units. In some embodiments, the one or more base stations of the 5G-RAN may be Evolved NodeB eNodeB (eNB). In some embodiments, the 5G-RAN may be a 3GPP radio access network (e.g. a RAN that operates using NR or LTE radio access technology as defined in the 3GPP standard). Although FIG. 1 illustrates a 5G-RAN, it will be appreciated by a person skilled in the art that access to the 5GC may be done via any wireless or wired access network, such as a non-3GPP access network (e.g., an untrusted wireless local area network (WLAN) which access the 5GC via a Non-3GPP Interworking Function (N3IWF), a trusted WLAN which accesses the 5GC via a Trusted Non-3GPP Gateway Function (TNGF), or a wireline network which accesses the 5GC via a Wireline Access Gateway function (W-AGF)). A non-3GPP access network is an access network that is not configured to communicate directly with a core network with an architecture and operations defined in the 3GPP standard.

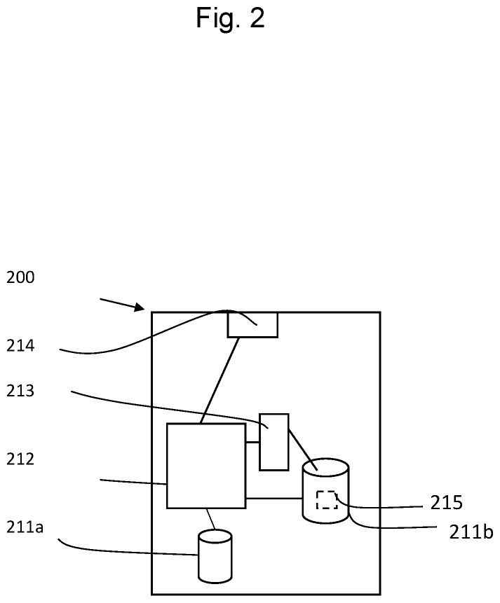

FIG. 2 illustrates an example of an apparatus 200 that may implement one or more NFs of the 5GC illustrated in FIG. 1. The apparatus 200 may comprise at least one random access memory (RAM) 211a, at least one read only memory (ROM) 211b, at least one processor 212, 213 and a network interface 214. The at least one processor 212, 213 may be coupled to the RAM 211a and the ROM 211b. The at least one processor 212, 213 may be configured to execute software code 215. The software code 215 may for example include instructions to perform actions or operations of one or more NFs of the 5GC. In some embodiments, the software code 215 may include instructions to perform one or more actions or operations of a federated learning (FL) aggregator in accordance with aspects of the present disclosure. The software code 215 may be stored in the ROM 211b. The apparatus 200 may implement one or more NFs of the 5GC and may be interconnected with another apparatus 200 implementing one or more other NFs of the 5GC. In such embodiments, the apparatuses 200 may be part of a distributed computing system. In some embodiments, each NF of the 5GC may be implemented on a single apparatus 200. In such embodiments, the apparatus 200 may be a cloud computing system.

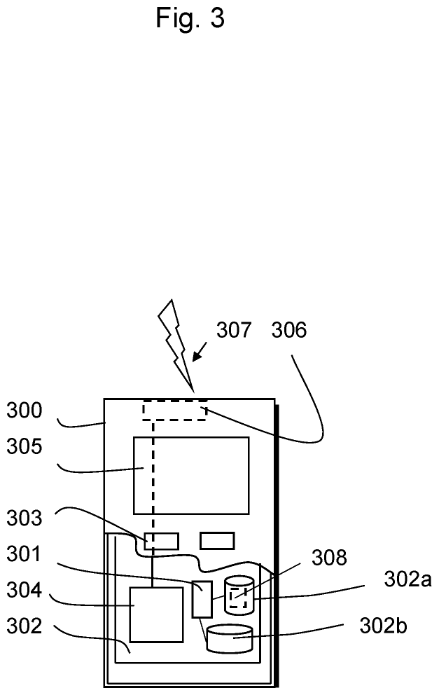

FIG. 3 illustrates an example of an apparatus 300 illustrated on FIG. 1. The apparatus 300 may be any wireless communication device capable of sending and receiving radio signals. Non-limiting examples of an apparatus 300 comprise a terminal, a wireless communication device, user equipment, a mobile station (MS) or mobile device such as a mobile phone or what is known as a ‘smart phone’, a computer provided with a wireless interface card or other wireless interface facility (e.g., USB dongle), a personal data assistant (PDA) or a tablet provided with wireless communication capabilities, a machine-type communications (MTC) device, an Internet of things (IoT) communication device or any combinations of these or the like. The apparatus 300 may be configured to communicate with base stations (e.g., a NG-eNB or a gNB) of an access network, such as the 5G-RAN and the 5GC via the base stations of the 5G-RAN using non-access stratum (NAS) signalling, for example, to communicate of data. The communications may include or carry one or more of voice, electronic mail (email), text message, multimedia, data, machine data and so on.

The apparatus 300 may receive wireless signals (e.g., radio or cellular signals) over an air or radio interface 307 (generally referred to as a Uu interface) via appropriate apparatus 306 for receiving the wireless signals and may transmit wireless signals e.g., radio or cellular signals) via appropriate apparatus for transmitting the wireless signals. In FIG. 3 the apparatus 306 includes one or more antennas (or an antenna array comprising a plurality of antennas) and a transceiver and is designated schematically by block 306. The apparatus 306 may be provided for example by means of a radio part and associated antenna arrangement comprising one or more antennas. The antenna arrangement may be arranged internally or externally to the mobile device.

The apparatus 300 may include at least one processor 301, at least one memory ROM 302a, at least one RAM 302b and other possible components 303 for use in software and hardware aided execution of tasks it is designed to perform, including control of access to and communications with access networks, such as the 5G-RAN, and other apparatuses 300. The at least one processor 301 is coupled to the RAM 311a and the ROM 311b. The at least one processor 301 may be configured to execute an appropriate software code 308. The software code 308 may for example include instructions which when executed by the at least one processor 301 perform one or more actions or operations of present aspects. The software code 308 may be stored in the ROM 311b.

The at least one processor 301, storage and other relevant control apparatus can be provided on an appropriate circuit board and/or in chipsets. This feature is denoted by reference 304. The terminal 300 may optionally have a user interface such as key pad 305, touch sensitive display screen or touch sensitive pad, combinations thereof or the like. Optionally one or more of a display, a speaker and a microphone may be provided depending on the type of the device.

Control or configuration of such communication systems has conventionally been done by control mechanisms which operate based on defined rules. To improve network performance (i.e., perform of networks in a communication system, such as a 5GS), control mechanisms implementing machine learning (ML) models have been proposed wherein network and/or management data from many network entities of the communication system can be processed by the ML models to generate suitable control outputs for such communication systems. Training of a machine learning (ML) model is centralized. The network and/or management data is collected by network entities (generally referred to as distributed nodes) and provided to one single network entity (generally referred to as a central node) to use the received data to train the ML model.

To minimize the amount of data exchanged between distributed nodes and the central node (where the training of a model (generally referred to as model training hereinafter) is usually implemented) and to prevent the privacy of data for each node being lost, a model can be trained using Federated Learning (FL). In FL, instead of training a model at the central node using the centralized data, the central node provides a global model comprising parameters or data to the distributed nodes and each of the distributed nodes performs local training of a local model (referred to hereinafter a local model training) using a dataset comprising data of the distributed node during an iteration of FL. In other words, each distributed node has a dataset (referred to hereinafter as a local dataset) and trains a local model using its own local dataset (i.e., performs local model training). In the following disclosure the terms local training and local model training are interchangeable. For each iteration of FL each distributed node then sends its local training results (e.g., the ‘learned’ parameters of its local model) to the central node.

During each iteration of FL, the central node receives local training results for the local models from the distributed nodes and combines or aggregates the local training results to obtain new global model parameters or data (global training results for the global model).

The local training results may comprise values for the parameters of the local models and the global training results may comprise aggregated values for the parameters of the global model.

The new global model parameters or data (e.g., the aggregated received local training parameter values) can then, in a further iteration of FL, be sent to the distributed nodes and the distributed nodes use these ‘new’ global model parameters as the parameters of their local models and perform further local training of the local models to learn new local model parameters. This process can be repeated until the values of parameters of the global model are optimized. The process of training the local models at the different distributed nodes is known to persons skilled in the art and is thus not described in further detail. For example Federated learning, and local and global models are described further within Konecny, Jakub, H. B. McMahan and Daniel Ramage. “Federated Optimization: Distributed Optimization Beyond the Datacenter.” ArXiv abs/1511.03575 (2015).

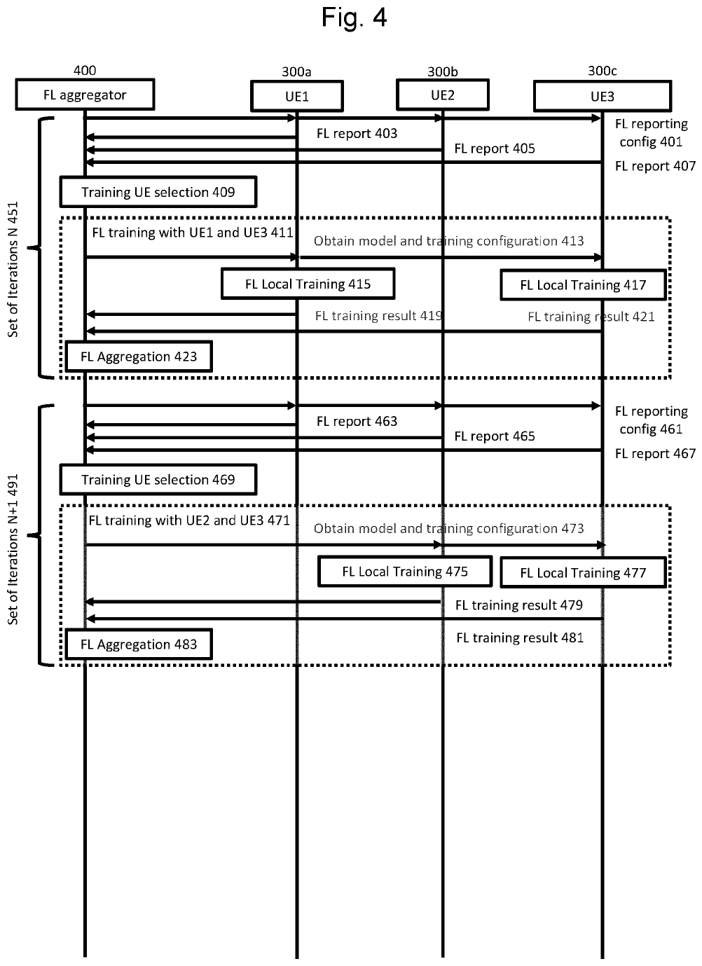

An example of communications between a central node and distributed nodes for training a model (e.g., a global model) using FL where the central node and the distributed nodes are part of or connected by a communication system, such as the 5GS of FIG. 1, is shown with respect to FIG. 4 and summarized below.

The example shown in FIG. 4 shows communications between a central node (referred to as a FL aggregator 400) and three distributed nodes (i.e., three apparatuses 300 which are denoted as UE1 300a, UE2 300b, and UE3 300c in FIG. 4) for two sets of iterations of FL, iteration set N 451 and iteration set N+1 491. However, there can be many more than two sets of iterations of FL. For each set of iterations of FL, there can be an initial sequence of communications. Communications between the FL aggregator 400 and the three distributed nodes include signalling and/or data communications. Signalling may be sent by the FL aggregator 400 to the distributed nodes via a NEF and AMF and the 5G-RAN or sent by the FL aggregator via the AMF and the 5G-RAN. Data communications may be sent by the FL aggregator 400 to a distributed node via the 5G-RAN, the UPF and the DN or sent by a wireless communication device. In FIG. 4, the 5G-RAN, the AMF, the NEF, the UPF and the DN and the communications between these network entities are omitted for ease of illustration. For example, the FL aggregator 400 can be configured to generate and send to each of UE1 300a, UE2 300b, and UE3 300c FL report configuration. The FL report configuration comprises information defining the content included in FL report, a format of the FL report and how to generate the FL report. For example, as shown in the first set of iterations 451 the FL aggregator 400 can be configured to generate and send to UE1 300a, UE2 300b and UE3 300c the FL report configuration at 401.

Then each of UE1 300a, UE2 300b, and UE3 300c can be configured to generate and send to the FL aggregator 400a FL report based on the FL report configuration. For example, UE1 300a is shown generating and sending a FL report to the FL aggregator at 403, UE2 300b is shown generating and sending a FL report to the FL aggregator at 405 and UE3 300c is shown generating and sending a FL report to the FL aggregator at 407. The FL report may include information useful for the FL aggregator 400 to assist the FL aggregator 400 in determining which of the UEs to select for FL (i.e., which of the UEs to select for training local models in the current iteration of FL, which can be abbreviated to local training in the following description). For example such information can comprise information indicative of resource availability at the UEs such as availability of processing resources (e.g., number of CPUs available at the UEs), availability of memory resources (amount of memory available at the UEs), available energy at the UEs, measurements indicative of quality (e.g. signal-to-noise ratio (SNR), reference signal receive power (RSRP)) of a radio link (e.g., a Uu link) between the UE and a base station of the 5G-RAN that may be a part of link between the UE and the FL aggregator 400, availability of data at the UEs for training a local model.

The FL aggregator 400 is then configured to select K UEs (2 UEs in this example shown in FIG. 4) for training a local model (otherwise referred to as local training herein) as shown in FIG. 4 at 409. The selection of UEs by the FL aggregator 400 can in some situations be random or based on any suitable UE selection scheme that takes into account the obtained FL reports (provided by the UEs).

In this example the FL aggregator 400 (for iteration N 451) selects UE1 300a and UE3 300c for FL.

The FL aggregator 400 is configured to then send the global model and training configuration as shown in FIG. 4 at 413. In other words, the FL aggregator 400 is configured to broadcast the global model (e.g., the aggregated training results or aggregated model parameter values from a previous iteration) and training configuration to the K selected UEs. Additionally the FL aggregator 400 can send training configuration to the K selected UEs to enable the selected UEs to perform local training. The FL aggregator 400 is configured to then send a signal to each of the selected UEs (e.g., UE1 and UE3) to perform local training of their local models. For example, for iteration N 451, FL is performed with UE1 and UE3 as shown by the dashed box 411. In other words the FL aggregator 400 sends a configuration to the selected UEs.

Then each of the selected UEs are configured to perform local training. For example, UE1 is configured to train a local model based on a local dataset stored at UE1 as shown in FIG. 4 at 415 and UE3 is configured to train a local model based on a local dataset stored at UE3 as shown in FIG. 4 at 417. Each of the K selected UEs, having received the global model and training configuration, configures their local model based on the global model and training configuration and updates the parameters of their local models to the received aggregated parameters. Then the K selected UEs are configured to perform local training.

Having performed local training, the K selected UEs are then configured to report the result of their local training (otherwise referred to herein as local training result). For example, the UEs are each configured to report their local training result to the FL aggregator 400. For example, with respect to UE1 300a, the local training result is reported (i.e., sent) by UE1 300a to the FL aggregator 400 in FIG. 4 at 419, and UE3 300c reports (i.e., sends) its local training result to the FL aggregator 400 in FIG. 4 at 423. A local training result reported by a particular UE may comprise updates for parameters of the local model at the particular UE. In some embodiments, the updates for the parameters of the local model are the values of the parameters of the local model when training of the local model has been completed at the UE. In some embodiments, the updates for the parameters of the local model are gradients of the parameters of the local model when training of the local model has been completed at the UE.

Furthermore the FL aggregator 400 is then configured to perform aggregation of the local training results (i.e., aggregate or combine the updates for the parameters of the local models) received from each of the K UEs (e.g., UE1 and UE3) as shown in FIG. 4 at 423.

Having performed the aggregation of the local training results, then FL is repeated with UE1 and UE3 for a predetermined number of iterations. In other words FL with UE1 and UE3 at 411 is repeated a number of times.

Furthermore FIG. 4 shows a further example set of iterations N+1 491 where there is a reselection of the UEs for FL. In the set of iterations N+1 491 UE2 300b and UE3 300c are selected by the FL aggregator 400 for FL. For example there is shown FL aggregator 400 configured to generate and send to UE1 300a, UE2 300b and UE3 300c the FL report configuration at 461.

Then each of the UEs can be configured to generate and send to the FL aggregator 400a FL report based on the FL report configuration. For example UE1 300a is shown generating and sending a FL report to the FL aggregator at 463, UE2 300b is shown generating and sending a FL report to the FL aggregator at 465 and UE3 300c is shown generating and sending a FL report to the FL aggregator at 467.

The FL aggregator 400 is then configured to select K UEs (2 UEs in this example) for local training as shown in FIG. 4 at 469.

In this example the FL aggregator 400 selects UE2 300b and UE3 300c for FL and implements FL for the set of iterations N+1 491 with UE2 and UE3 as shown by the dashed box 471.

The FL aggregator 400 is then configured to perform broadcasting of the global FL model and training configuration as shown in FIG. 4 at 473. The broadcasting of the global FL model and training configuration comprises sending the global model and training configuration to each of UE2 300b and UE3 300c.

Then each of the selected UEs are configured to perform local training. For example UE2 300b is configured to train a local model based on UE2 data as shown in FIG. 4 by step 475 and UE3 is configured to train a local model based on UE3 data as shown in FIG. 4 at 477. The local training of each of the selected UEs is performed.

Having performed local training, the K selected UEs then report their local training results to the FL aggregator 400. For example with respect to UE2 300b the local training result is provided (e.g., sent) to the FL aggregator 400 in FIG. 4 at 479, and with respect to UE3 300c, the local training result is provided (e.g., sent) to the FL aggregator 400 in FIG. 4 at 481. A local training result may be values of the parameters of a local model after training is performed.

Furthermore the FL aggregator 400 is then configured to perform a combination or aggregation of the local training results received from the K UEs as shown in FIG. 4 at 483 to obtain aggregate training results for the global model.

Having performed the FL aggregation operation to combine or aggregate the local training results to obtain the model parameters of the local models to generate the aggregated training results for the global model, the ‘local’ training process with UE2 and UE3 is repeated for a (further) predetermined number of times. In other words, the training of local UE2 and UE3 models as shown by box 461 is repeated a number of times.

Then the FL iteration sets can be repeated or continued until the FL model converges (i.e., until the parameters of the global model are optimized).

When FL is implemented in a communication system, such a 5G system, during each FL iteration, UEs receive from the FL aggregator 400 located within, for example, a network entity (otherwise known as a network function) of a core network of the 5G system, an indication to perform training of a local model using the local dataset. Then, the UEs report the local training results (for example the values of the parameters of the local model after local training has been completed, updates for the parameters of the local model after local training has been completed, or gradients for the parameters of the local model after local training has been completed) to the FL aggregator 400. The FL aggregator 400 then combines or aggregates the local training results for the local models received from the UEs to obtain aggregate training results for the global model (e.g., to obtain values for the parameters of the global model). Next, the aggregate training results (e.g., the values of the parameters of global model) are included in the global model sent to the UEs in a subsequent iteration of FL. The UEs can then begin the training for the next FL iteration.

An example use case for the Federated Learning embodiments described hereafter can be training a machine learning model (i.e., a global model) which is configured to predict Quality of Service (QoS) for device-to-device (D2D) communications over a sidelink (SL) between two devices, such as two apparatuses 300. The global model can in some embodiments require data such as geographical location (or zone) of the two devices, SL Received Signal Strength Indicator (SL RSSI) for the SL between the two devices, SL Reference Signal Received Power (SL RSRP) for the SL between the two devices, SL Channel State Information (SL CSI) for the SL between the two devices, SL Channel Busy Ratio (SL CBR) for the SL between the two devices, SL transmission parameters (e.g., modulation and coding scheme (MCS) for the SL between the two devices, a transmission power for communications on SL between the two devices, number of retransmission on for the SL between the two devices, priority, etc.), and/or SL Hybrid Automatic Repeat Request (SL HARQ) feedback for training the global model.

Conventionally, for models that are centrally trained (i.e., trained at a central node), this data would have to be transmitted from the two devices to a central node via a communication system, for example a 5G system. For the use case described previously a ML model which is configured to predict a QoS for D2D communications over a SL between two devices may be implemented in a network entity of a core network of a 5G system. This ML model requires data for SL measurements (e.g. to predict a QoS for D2D communications over a SL between two devices. However, data for SL measurements are typically only available at the devices and the data for SL measurements are not typically sent to the core network of the 5G system. Any attempt to transmit the data for SL measurements to the core network of the 5G system can significant increase the signalling transmitted over the air interface (e.g., the Uu interface) between a device and the base station of a 5G-AN which may not be desirable. Therefore training a ML model using federated learning, such as described in the embodiments herein, can be beneficial in such scenarios to eliminate the need for the devices (e.g., UEs) to send their local training data to a core network which reduces signalling between the devices (e.g., UEs) and the core network and eliminates privacy concerns as only the local training results (e.g., the values of the model parameters of the locally trained models or gradients of the parameters of the locally trained models) are transmitted from the devices (e.g. UEs) to the core network.

The embodiments as described herein further aim to improve the performance of FL in a 5GS. Current FL involve reselection of UEs for FL (referred to hereinafter as training UEs) which increases signalling sent between the FL aggregator 400 and UEs selected for FL over the air interface as well as adding latency with respect to model training using FL. It is noted that selecting and configuring training UEs for FL requires an increased amount of signalling to be exchanged between the FL aggregator 400 and UEs.

Furthermore when an already selected training UE cannot effectively participate in training of a global model (otherwise referred to as model training) using FL, for example because of a poor quality of the air interface (e.g., the Uu link) between a UE and a base station of a RAN, or because of (temporary) unavailability of local resources of the UE (e.g. computation resources, such as an amount of memory or processing resources available at the UE, power, etc.), the FL aggregator 400 may need to reselect training UEs that participate in the model training using FL. This reselection of training UEs can further cause additional signalling to be sent between the FL aggregator 400 and the selected UEs and can further cause delays in model training using FL due to increases in latency.

These issues can become particularly significant where a UE's unavailability (on and off availability of a UE) is frequent causing frequent reselections of training UE that participate in model training using FL at the FL aggregator 400. In addition, among UEs with local data sets having similar data distributions, the FL aggregator 400 may select only one (fewer) UE(s) to participate in model training using FL to avoid bias in the trained global model towards a particular data distribution. This naturally puts the UE or UEs which are chosen as the training UE at a disadvantage as the selected UE or UEs must participate in model training of the global model using FL with an associated expense of applying resources (such as power usage and/or processor and/or memory) required to be used when performing local training of a local model using a local dataset.

The following embodiments thus aim to provide a FL aggregator which minimizes reselection of UEs that participate in model training using FL, minimizes signalling sent to UEs selected for model training using FL (i.e., signalling overhead between FL aggregator and the UEs), avoids interruptions during model training using FL and avoids unfair exploitation of UEs during model training using FL.

For example in some embodiments a FL aggregator configures a training UE (which is referred to in this application as a first UE or primary UE) with a substitute training UE (which is also referred to in this application as a second UE, or secondary UE). In these embodiments the second UE is activated as the training UE (i.e., performs local training) only upon the unavailability of the first UE for local training.

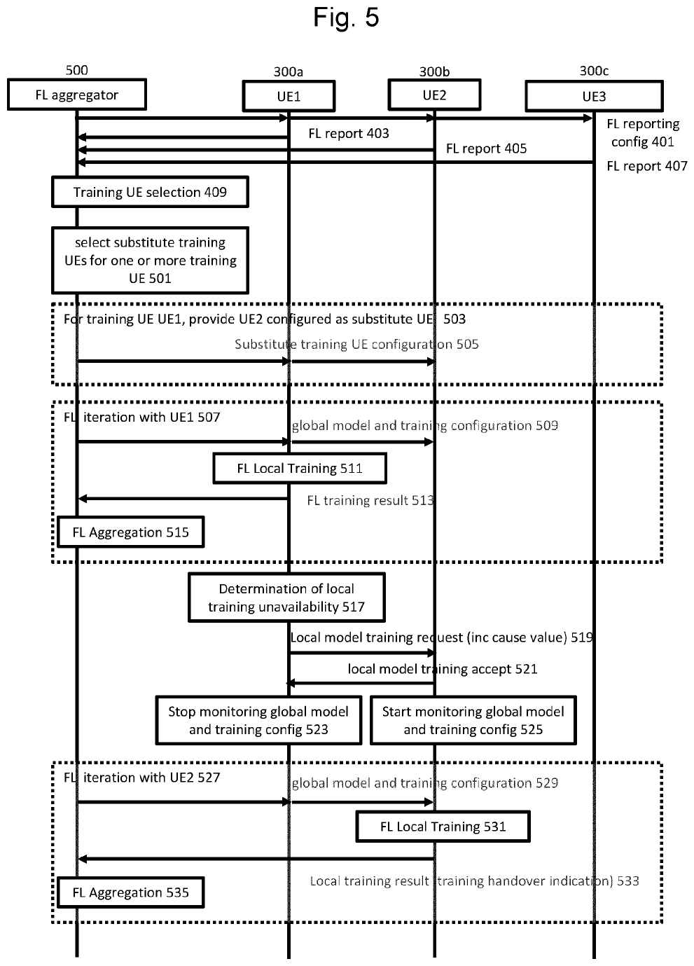

Communications (i.e., signalling) between a FL aggregator 500 according to an embodiment of the present disclosure and the first UE and a second UEis shown in FIG. 5. In the embodiment shown in FIG. 5, each of the UEs. UEs 300a, 300b, 300c, communicate with the FL aggregator 500 via link that comprises a wireless link (e.g. a Uu link) between the UE and a base station of a RAN of a communication system and wired link between the base station and the FL aggregator 500.

The initial operations performed by the FL aggregator 500 are similar to the initial operations performed by the FL aggregator 400 shown in FIG. 4 and described above.

The FL aggregator 500 can be configured to generate and send to each of the UEs a FL report configuration. The FL report configuration can comprise information defining content to be included in a FL report, a format for the FL report and how to generate the FL report. For example, the FL aggregator 500 can be configured to generate and transmit to UE1 300a, UE2 300b and UE3 300c the FL report configuration at 401.

Then each of the UEs, UEs 300a, 300b, 300c, can be configured to generate and send to the FL aggregator 500a FL report based on the FL report configuration. For example, UE1 300a is shown generating and sending a FL report to the FL aggregator at 403, UE2 300b is shown generating and sending a FL report to the FL aggregator at 405 and UE3 300c is shown generating and sending a FL report to the FL aggregator at 407. The FL report can include information useful for the FL aggregator 500 to assist the FL aggregator 500 in determining which UEs to select for FL. For example, such information can comprise training resource availability at the UEs such as CPUs, energy, measurements related to a quality of a radio link (e.g., RSRP) that may be a part of link between the UE and the FL aggregator 500, availability of local data at the UEs for training a local model at the UE (otherwise referred to as training data availability).

The FL aggregator 500 is then configured to select K UEs for local training as shown in FIG. 5 at 409. The selection of K UEs for local training can in some situations be random or based on any suitable UE selection scheme that takes into account the information included in the received FL reports (provided by the UEs). In the following example one of the selected UEs is UE1 300a. In the following description this selected UE is a first UE. In the following example the FL signalling is shown with respect to the selected UE UE1 300a for local training. It would be understood that similar signalling flows would also be implemented for the other selected UEs such as for example UE3 300c which could also have been selected as a first UE along with UE1 300a.

Additionally the FL aggregator 500 is configured to select a second UE as the substitute training UE for the first UE as shown in FIG. 5 at 501. The selection of the second UE as the substitute training UE for the first UE, which in the example shown herein is UE2 300b, can be a selection of one or more candidate UEs based on at least one of the following selection criteria:
a training UE selection assistance information received from the first UE (for example UE1 300a), where the first UE includes information identifying candidate substitute training UEs in the training UE selection assistance information;
a data distribution of the data in the local dataset at the first UE and a data distribution of the data in the local dataset at each candidate substitute training UE;
a mobility pattern of the candidate substitute training UEs relative to the first UE;
at least one characteristic of wireless link (i.e., Uu link) between each candidate substitute training UE and the base station of the RAN;
a location of first UE and each of the candidate substitute training UEs.

For example with respect to the data distribution of the local datasets of the candidate substitute training UEs, it is noted that the FL aggregator 500 typically does not select two training UEs (in the same iteration) which have very similar data distributions to avoid bias in the trained global model. Therefore, the UE which is not selected as a training UE at 409 due to having a similar data distribution as the data distribution of the local dataset of the already chosen training UE can be chosen as the substitute training UE to the already chosen training UE. This way, even when the training UE is not available for local training, a substitute training UE can perform local training using a local dataset which is similar to the local dataset of the already chosen training UE. Furthermore selection of a substitute training UE or second UE based on the location of the first UE and each of the candidate substitute training UEs can be based on whether candidate substitute trainings UEs that are located nearby to (e.g., within a predetermined distance of) the first UE are likely to have similar data, particularly when the training data in the local datasets comprises a measurement of a quality of a Uu link between a candidate substitute training UE and the base station of the RAN or a measurement of a quality of the sidelink between the first UE and a candidate substitute training UE. Hence, a nearby candidate substitute training UE can be chosen as the substitute training UE or second UE.

Selection of a substitute training UE or a second UE selection based on a mobility pattern of the of the candidate substitute training UEs relative to the first UE can be based on whether a nearby candidate substitute training UE or candidate substitute training UEs are moving together with the first UE (e.g., the first UE and the candidate substitute UEs are platooning). The mobility pattern can for example consider the trajectory and/or velocity of the candidate substitute training UEs relative to the first UE. The selection of a second UE based on proximity and relative mobility results in a second UE which is likely to have similar data particularly when the training dataset includes training data indicative of wireless link (i.e., Uu link) measurement or sidelink measurement. Hence, a nearby UE can be chosen as the substitute training UE.

In some embodiments the selection of a substitute training UE or a second UE from the candidate substitute training UEs can be based on a sidelink reachability parameter value. The sidelink reachability parameter value can relate to the ability of the first UE to directly communicate with a candidate substitute training UE. The sidelink reachability parameter value can in some embodiments be determined based on information available at the base station (e.g. gNB) of the RAN from SL related measurement reporting in SL communication and SL relay related scenarios. For example the selection of a substitute training UE or a second UE from the candidate substitute training UEs can be configured to select a substitute training UE with a good quality communication link between the first UE and candidate substitute training UE so that when selected a handover between the first (training) UE and the second (substitute training) UE is not likely to fail.

The selection criteria of at least one characteristic of the wireless link (e.g., Uu link) between a candidate substitute training UE and a base station or a RAN can be based on ensuring that when the training UE cannot participate in FL due to failure of the wireless link (e.g., Uu link) a candidate substitute training UE can participate in FL.

The FL aggregator 500 is then caused to configure the selected second UE, in this example UE2 300b as the substitute training UE for the first UE, UE1 300a such as shown in FIG. 5 at 503. The operation of configuring the second UE as the substitute training UE for the first UE can comprise generating a substitute training UE configuration and sending the substitute training UE configuration to the first and second UEs, where the substitute training UE configuration sent to the first UE and second UE comprises an identifier of the second UE and first UE respectively as shown in FIG. 5 at 505. In some embodiments the substitute training UE configuration sent to the first UE and second UE can comprise:
a unique ID of the training UE;
a unique ID of the substitute training UE;
at condition identifier configured to identify a one trigger condition which triggers transferring local model training from training UE to the substitute training UE.

In some example embodiments, the trigger condition which triggers transferring local model training from training UE to the substitute training UE can comprise:
a minimum quality of a wireless link (e.g., a Uu link) between the training UE and the base station (e.g., gNB) of the RAN that the training UE must have to continue to be a training UE;
a minimum computation and power resource that the training UE must have to continue to be a training UE; and
a minimum security/integrity level associated with the local dataset of the training UE which must be met.

Having sent the substitute training UE configuration to the first UE, UE1 300a, and second UE, UE2 300b such that the second UE is a substitute training UE for the first UE, UE1 300a then the FL aggregator 500 can perform FL using training of the local model at the first UE can be implemented as shown in FIG. 5 at 507.

The training of the model at the first UE, UE1 300a, during FL with the first UE, UE1 300a, (or FL with UE1) can in some embodiments comprise the FL aggregator 500 broadcasting or otherwise sending the global model and training configuration to selected first UEs and selected second UEs as shown in FIG. 5 at 509. In other words the FL aggregator 500 is configured to broadcast the global model and training configuration to the K selected first UEs (and furthermore the selected second UEs associated with the selected first UEs).

Then each of the selected first UEs are configured to perform local training. For example UE1 performs local training as shown in FIG. 5 at 511. The local training performed at all of the K selected first UEs having received global model and training configuration the first UEs are configured to update their respective local models based on the global model and training configuration.

Having performed local training, each of the K selected first UEs are then configured to report the result of their local training (i.e., a local training result). For example the selected first UEs are configured to send the local training results to the FL aggregator 500. With respect to UE1 300a the local training result is sent to the FL aggregator 500 in FIG. 5 at 513. The local training result sent by each of the selected first UEs may be values of the parameters of the local model when local training has been completed, updates of the parameters of the local model, or gradients of the parameters of the local model. The updates of the parameters of the local model can be the difference between the original values of the parameters and the final values of the parameters after local training is complete.

Furthermore the FL aggregator 500 is then configured to perform aggregation of the training results received from the distributed nodes (selected first UEs) as shown in FIG. 5 at 515. In other words, the FL aggregator 500 aggregates or combines the local training results to obtain aggerated training results for the global model and updates the parameters of the global model based on the aggregated training results.

In some embodiments the second UE is configured to perform local model training upon determination of unavailability of first UE for local model training. In some embodiments the second UE (also known as the substitute UE or secondary UE) is configured to perform the local model training based on receiving a local training activation request (comprising an indication of the unavailability of the first UE to be able to perform local model training) from the selected first UE or the FL aggregator 500.

Thus, for example, as shown in FIG. 5 the first UE, UE1 300a, is configured to determine that the first UE is experiencing a local training unavailability event as shown in FIG. 5 at 517. For example, in some embodiments, the training UE (first UE) is configured to evaluate the at least one trigger condition which triggers transferring local model training to a substitute training UE (included in the substitute training UE configuration). An example of a trigger condition which triggers transferring local model training to a substitute training UE which is monitored can be when a quality of the wireless link (e.g., Uu link) between a base station and the first UE falls below a threshold which causes the first UE, UE1 300a, to initiate a transfer of local model training to the second UE, UE2 300b.

The first UE, UE1 300a, can thus be configured to generate and send to the second UE, UE2 300b, a request to perform local model training (or model training transfer request) as shown in FIG. 5 at 519. The request to perform local model training (otherwise referred to herein as local model training request) in some embodiments may further contain an indication of the cause for the transfer of local model training to the second UE, UE2 300b and/or a time duration in which the local model training is to be performed at the second UE, UE2 300b.

The second UE, UE2 300b, can then be configured to generate a local training accept message (which in some embodiments can be an acknowledgement or response message) in response to accepting to perform local model training and send the local training accept message to the first UE as shown in FIG. 5 at 521. The local training accept message generated by the second UE, UE2 300b indicates to the FL aggregator 500 that the second UE, UE2 300b, will perform local model training using a local dataset.

In some embodiments the first UE, for example UE1, is configured to send an indication on its unavailability to the FL aggregator 500 and the FL aggregator 500 is configured to either forward this indication to the second UE or explicitly activate the second UE, UE2 300b, for local model training during the FL iteration (by generating a suitable trigger message or model training transfer request). It is noted that the FL aggregator 500 does not perform reselection of training UEs at this stage, but merely sends an activation message to the second UE (or substitute UE). In such embodiments the second UE, UE2 300b, is then configured to send a local training accept message (or acknowledgement or response) directly to the FL aggregator 500 rather than the first UE as shown in FIG. 5.

The first UE, UE1 300a, is then configured to stop monitoring for global model and training configuration sent by the FL aggregator 500 as shown in FIG. 5 at 523 and the second UE, UE2 300b, is configured to start monitoring for global model and training configuration sent by the FL aggregator 500 as shown in FIG. 5 at 525.

This in effect enables the second UE, UE2 300b, to start local model training. This is shown in FIG. 5 at 527 as a local training with UE2 300b.

The local training at UE2 300b, during a FL iteration can in some embodiments comprise the FL aggregator 500 performing broadcasting of a global model and training configuration as shown in FIG. 5 at 529.

Then each of the ‘active’ second UEs are configured to perform local model training. For example UE2 300b performs local model training (i.e., local training of a local model using a local dataset) as shown in FIG. 5 at 531.

Having performed local training, the ‘active’ second UEs are then configured to report their local training result to the FL aggregator 500. For example with respect to UE2 300b the local training result is reported to the FL aggregator 500 in FIG. 5 at 533 by for example, sending a message that includes the local training result.

In embodiments where the second UE (e.g. UE2 300b) is configured to perform local model training based on receiving a local training activation request (comprising an indication of the unavailability of the first UE (e.g., UE1 300a) to be able to perform local model training) from the selected first UE or the FL aggregator 500, the second UE (e.g. UE2 300b) may send to the FL aggregator 500, in addition to the local training result, an indication that the second UE is participating in FL (i.e., an indication that the second UE is a substitute training UE for the first UE) so that the FL aggregator 500 does not discard the local training result sent by the second UE. The local training result and the indication may be included in a message sent by the second UE (e.g., UE2 300b) to the FL aggregator 500. The indication that the second UE is participating in FL to the FL aggregator 500 is otherwise referred to herein as a training handover indication and is shown in FIG. 5 at 533.

Furthermore the FL aggregator 500 is then configured to perform aggregation of the received local training results as shown in FIG. 5 at 535.

Thus in these embodiments as shown above the FL aggregator 500 is configured to use the local training results sent by the second UE (or substitute UE) in a FL iteration when the first UE is unavailable to perform local model training (or is unable to report its local training results to the FL aggregator 500). After receipt of the local training results, the FL aggregator 500 is configured to perform aggregation or combination of the local training results to obtain aggregated training results for the global model. Furthermore in some embodiments the FL aggregator 500 is configured to further indicate or register the change in the training UE performing local model training to maintain a log of availability of training UEs for local model training, or transfers of local model training to substitute training UEs.

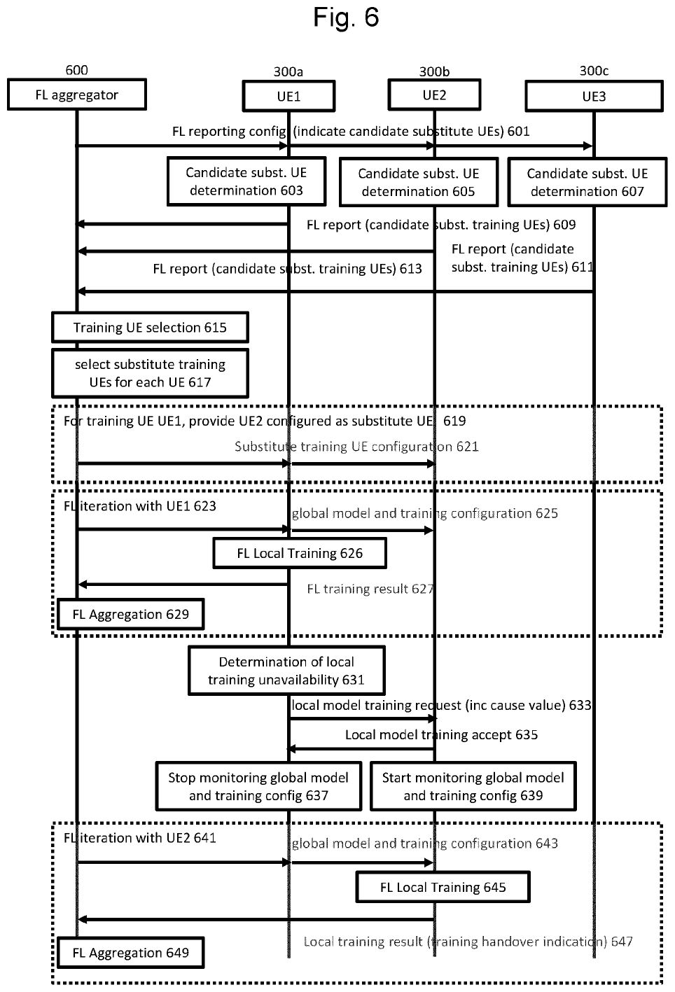

In some embodiments the FL aggregator 500 is further configured to request and obtain candidate substitute training UEs (UEs that are preferred as substitute training UEs) as determined by each selected training UE. In other words UEs can be requested by the FL aggregator 500 to provide information identifying other UEs which could be selected as second UE or substitute training UE when the UE is selected as a first UE (i.e., the training UE). Communications (i.e., signalling) between a FL aggregator 600 according to a further embodiment of the present disclosure and the first UE and a second UE is shown in further detail in FIG. 6. In the embodiment shown in FIG. 6, the communications (e.g., signalling) is modified to incorporate preferred candidate information. In the following example a candidate node (for example a candidate first UE or candidate second UE is respectively a UE which can be potentially selected as the first UE or second UE.

In the embodiment shown in FIG. 6, each of the UEs. UEs 300a, 300b, 300c, communicate with the FL aggregator 600 via a link that comprises a wireless link (e.g. a Uu link) between the UE and a base station of a RAN of a communication system and wired link between the base station and the FL aggregator 600.

The initial operations performed by the FL aggregator 600 are similar to the initial operations performed by the FL aggregator 400 shown in FIGS. 4 and 5 and described above.

The FL aggregator 600 can be configured to generate and transmit to each of the UEs a FL report configuration. The FL report configuration can comprise, as indicated above, information defining content to be included in the FL report, a format for the FL report and how to generate the FL report. The FL report configuration (for example information defining the content to be included in the FL report), in some embodiments, further requests that the FL report comprises information indicating candidate (or preferred) substitute training UEs. For example the FL aggregator 600 can be configured to generate and transmit to UE1 300a, UE2 300b and UE3 300c the FL report configuration comprising a request to indicate candidate substitute training UEs at 601.

Each candidate first UE (when instructed) can in some embodiments be configured to determine one or more candidate substitute training UEs (or candidate second UEs). In some embodiments the determination of candidate substitute training UEs can be based on at least the following:
a data distribution of the data in the local datasets at the candidate first UE and a data distribution of the data in the local datasets at the candidate substitute training UEs (the reasons being similar to those described above with respect to FIG. 5). In such embodiments a candidate first UE, for example UE1 300a can be configured to request neighbouring UEs to report the data distribution of their data in their local dataset at the neighbouring UEs. The data distribution can for example be any or any combination of: range, interquartile range, standard deviation, variance;
a location proximity between the candidate first UE and candidate substitute training UEs and/or mobility pattern of the candidate substitute training UEs relative to the candidate first UE (for the same reasons as discussed above with respect to FIG. 5). For example the candidate first UE can be configured to request neighbouring candidate substitute training UEs to report their location and mobility pattern, or the candidate first UE can be configured to compute proximity and relative mobility of neighbouring candidate substitute training UEs by monitoring parameters such as cooperative awareness messages sent by the neighbouring candidate substitute training UEs on a sidelink or by monitoring SL-RSRP.

Thus for example in FIG. 6 UE1 300a determines a candidate substitute training UE list (with respect to UE1 300a) at 603, UE2 300b determines a candidate substitute training UE list (with respect to UE2 300b) at 605, and UE3 300c determines a candidate substitute training UE list (with respect to UE3 300c) at 607.

Then each of the UEs can be configured to generate and send to the FL aggregator 600a FL report based on the FL report configuration, where the FL report configuration further comprises identified candidate second UE or candidate substitute training UEs. For example UE1 300a is shown generating and sending a FL report to the FL aggregator comprising candidate substitute training UEs at 609, UE2 300b is shown generating and sending a FL report to the FL aggregator at 611 and UE3 300c is shown generating and sending a FL report to the FL aggregator at 613.

The FL aggregator 600 is then configured to select K UEs for local training as shown in FIG. 6 at 615. In the following example one of the selected first UEs is UE1 300a and another of the selected first UEs is UE3, 300c. In the following example Figure the FL signalling is shown with respect to the selected UE, UE1 300a, for local training. It would be understood that similar signalling flows would also be implemented for the other selected UE UE3 300c.

Additionally the FL aggregator 600 is configured to select a second UE as the substitute training UE for the first UE as shown in FIG. 6 at 617. The selection of the second UE as the substitute training UE for the first UE, which in the example shown herein is UE2 300b, can be based on the candidate substitute list included in the FL report received from UE1 300a. In some embodiments the selection of the second UE s the substitute training UE for the first UE is based on the candidate list and furthermore any of the other selection criteria for the substitute training UE mentioned above.

The signalling flows between the FL aggregator 600 and the training UE (first UE) and the substitute training UE (second UE) can then be similar to those discussed above.

For example the FL aggregator 600 can be then caused to configure the selected second UE, in this example UE2 300b as the substitute training UE for the first UE, UE1 300a such as shown in FIG. 6 at 619. The operation of configuring the second UE as the substitute training UE for the first UE can comprise generating a substitute training UE configuration and sending the substitute training UE configuration to the first and second UEs, where the substitute training UE configuration sent to the first UE and second UE comprises an identifier of second UE and first UE respectively as shown in FIG. 6 at 621.

Having sent the substitute training UE configuration to the first UE, UE1 300a, and second UE, UE2 300b such that the second UE is a substitute training UE for the first UE, UE1 300a, then the FL aggregator 600 can perform FL using training of the local model at the first UE can be implemented as shown in FIG. 6 at 623.

The training of the model at the first UE, UE1 300a, during FL with the first UE, UE1 300a, (or FL with UE1) can in some embodiments comprise the FL aggregator 600 broadcasting or otherwise sending the global model and training configuration to selected first UEs and selected second UEs as shown in FIG. 6 at 625. In other words the FL aggregator 600 is configured to broadcast the global model and training configuration to the K selected first UEs (and furthermore the selected second UEs associated with the selected first UEs).

Then each of the selected first UEs are configured to perform local model training. For example UE1 300a performs local model training as shown in FIG. 6 at 626. The local model training performed at all of the K selected UEs having received global model and training configuration the first UEs are configured to update their respective local models based on the global model and training configuration.

Having performed local model training, each of the K selected first UEs are then configured to report (their local training results) to the FL aggregator 600. For example, the selected first UEs are configured to send the local training results to the FL aggregator 600, such as shown in FIG. 6 at 627 where the local training results are sent by UE1 300a to the FL aggregator 600. (Although not shown other selected first UEs, for example UE3 300c, are configured to report the result of their local training). The local training result sent by each of the selected first UEs may be values of the parameters of the local model when local training has been completed, updates of the parameters of the local model, or gradients of the parameters of the local model. The updates of the parameters of the local model can be the difference between the original values of the parameters and the final values of the parameters after local training is complete.

Furthermore the FL aggregator 600 is then configured to perform aggregation of the training results received from the distributed nodes to obtain aggregated training results for the global model as shown in FIG. 6 at 629. In other words, the FL aggregator 600 aggregates or combines the local training results to obtain aggerated training results for the global model and updates the parameters of the global model based on the aggregated training results.

In some embodiments the second UE is configured to perform local model training upon determination of unavailability of first UE for local training. In some embodiments the second UE (also known as the substitute training UE or secondary UE) is configured to perform the local training of a local model based on receiving a local training activation request (comprising an indication of the unavailability of the first UE to be able to perform local training) from the selected first UE, UE1 300a, or the FL aggregator 600.

Thus for example as shown in FIG. 6 the first UE, UE1 300a, is configured to determine that the first UE is experiencing a local training unavailability event as shown in FIG. 6 at 631.

The first UE, UE1 300a, is then configured to generate and send to the second UE, UE2 300b, a request to perform local model training (or a model training transfer request) as shown in FIG. 6 at 633. The request to perform local model training (otherwise referred to herein a local model training request) in some embodiments may further contain an indication of the cause for the transfer of local model training to the second UE, UE2 300b (or substitute training UE) and/or a time duration in which the local model training is to be performed at the second UE UE2 300b.

The second UE, UE2 300b, can then be configured to generate a local model training accept message (which in some embodiments can be an acknowledgement or response message) in response accepting to perform local model training and send the local model training accept message to the first UE as shown in FIG. 6 at 635. The local model training accept message generated by the second UE, UE2 300b indicates to the first UE, UE1 300a that the second UE, UE2 300b, will perform local model training (i.e., perform local training of a local model using a local dataset).

As above, in some embodiments the first UE, for example UE1, is configured to send an indication on its unavailability to the FL aggregator 600 and the FL aggregator 600 is configured to either forward this indication to the second UE or explicitly activate the second UE, UE2 300b, for local model training (by generating a suitable trigger message or model training transfer request). In such embodiments the second UE, UE2 300b is then configured to send to the FL aggregator 600a local model training accept message (e.g., a suitable acknowledgement or response message) in response accepting to perform local model training.

The first UE, UE1 300a, is then configured to stop monitoring for global model and training configuration sent by the FL aggregator 600 as shown in FIG. 6 at 637 and the second UE, UE2 300b, is configured to start monitoring for global model and training configuration sent by the FL aggregator 600 as shown in FIG. 6 by step 639.

This in effect enables the second UE, UE2 300b, to start local model training as shown in FIG. 6 at 641.

The local model training is performed at UE2 300b, during a FL iteration can in some embodiments comprise the FL aggregator 600 performing broadcasting of a global model and training configuration as shown in FIG. 6 at 643.

Then each of the ‘active’ second UEs are configured to perform local model training (i.e., local training of a local model using a local dataset). For example UE2 300b performs local model training (i.e., local training of a local model using a local dataset) as shown in FIG. 6 at 645.

Having performed local model training, the ‘active’ second UEs are then configured to report their local training results to the FL aggregator 600. For example with respect to UE2 300b the local training result is reported to the FL aggregator 600 in FIG. 6 at 647 by for example, sending a message comprising the local training result.

In embodiments where the second UE (e.g. UE2 300b) is configured to perform local model training based on receiving a local training activation request (comprising an indication of the unavailability of the first UE (e.g., UE1 300a) to be able to perform local model training) from the selected first UE or the FL aggregator 600, the second UE (e.g. UE2 300b) may send in addition to the local training result, an indication that the second UE is participating in FL (i.e., an indication that the second UE is a substitute training UE for the first UE) to the FL aggregator 600 so that the FL aggregator 600 does not discard the local training result sent by the second UE. The local training result and the indication may be included in a message sent by the second UE (e.g., UE2 300b) to the FL aggregator 600. The indication that the second UE is participating in FL to the FL aggregator 600 is otherwise referred to herein as a training handover indication and is shown in FIG. 6 at 647. Furthermore the FL aggregator 600 is then configured to perform aggregation of the received local training results as shown in FIG. 6 at 649.

In some embodiments the training UE and/or the substitute training UEs can be configured to reject the substitute training UE configuration provided by the FL aggregator 600. For example in a situation when second UE is not reachable from the first UE over a sidelink (SL) then the first UE can reject the substitute training UE configuration. Similarly the second UE can reject the substitute training UE configuration provided by the FL aggregator 600 when the first UE is not reachable over a sidelink from the second UE.

In other words the embodiments show that the first UE or second UE can accept or reject substitute training UE configuration received from the FL aggregator 600 based on a determination of whether the second UE would receive (or not receive) the local model training request from the first UE or whether the first UE would receive (or not receive) the local model training accept from the second UE. The rejection of the substitute training UE configuration can then cause or trigger the FL aggregator 600 to provide a new substitute training UE configuration.

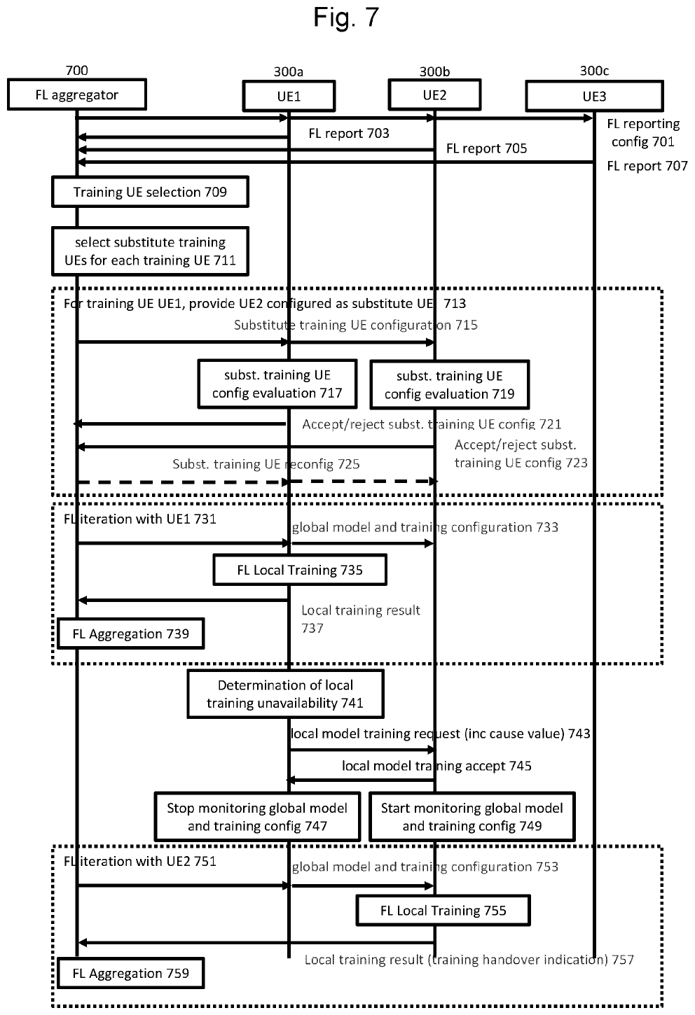

This signalling associated with an example rejection of substitute training UE configuration is shown with respect to FIG. 7 which builds on the example shown in FIG. 5 modified to incorporate the ability of the first UEs and second UEs to accept or reject the substitute UE training configuration received from the FL aggregator.

The initial operations are similar to the implementation shown in FIG. 5.

The FL aggregator 700 can be configured to generate and send to each of the UEs a FL report configuration. The FL report configuration can comprise information defining content to be included in a FL report, a format for the FL report and how to generate the FL report (and in some embodiments a substitute candidate list). For example the FL aggregator 700 can be configured to generate and send to UE1 300a, UE2 300b and UE3 300c the FL report configuration at 701.

Then each of the UEs, UE 300a, 300b, 300c, can be configured to generate and send to the FL aggregator 700a FL report based on the FL report configuration (and in some embodiments further determine and output the candidate list).

For example UE1 300a is shown generating and sending a FL report to the FL aggregator at 703, UE2 300b is shown generating and sending a FL report to the FL aggregator at 705 and UE3 300c is shown generating and sending a FL report to the FL aggregator at 707.

The FL aggregator 700 is then configured to select K UEs for local model training as shown in FIG. 7 at 709. The selection of K UEs for local model training can be based on any of the above selection schemes.

Additionally the FL aggregator 700 is configured to select a second UE as the substitute training UE for the first UE as shown in FIG. 7 at 711. The selection of the substitute training UE can be based on any of the above selection schemes.

The FL aggregator 700 is then caused to configure the selected second UE, in this example UE2 300b as the substitute training UE for the first UE, UE1 300a such as shown in FIG. 7 at 713.

Configuring the second UE as the substitute training UE for the first UE, UE1 300a, can comprise generating a substitute training UE configuration and sending the substitute training UE configuration to the first and second UEs where the substitute training UE configuration sent to the first UE and second UE comprises an identifier of the second UE and first UE respectively as shown in FIG. 7 at 715.

In these embodiments the first UEs and second UEs are configured to evaluate whether the substitute training UE configuration is able to be implemented or is acceptable for the UE which receives the substitute training UE configuration.

Thus the UE1 300a is configured to evaluate whether the substitute training UE configuration is able to be implemented at UE1 300a or is acceptable to UE1 300a at 717 and UE2 300b is configured to evaluate whether the substitute training UE configuration is able to be implemented at UE2 300b or is acceptable to UE2 300b at 719. As indicated above the evaluation of whether the substitute training UE configuration is able to be implemented at a UE or is acceptable to a UE can be based on whether a local model training request or local model training accept can be sent from the first UE to the second UE or from the second UE to the first UE respectively over the sidelink between the first UE and second UE.

The UE (for example a first UE, UE1 300a, and a second UE, UE2 300b) can be configured to generate and send an accept message when the substitute training UE configuration is able to be implemented at the UE or is acceptable to the UE or a reject message when the substitute training UE configuration is not able to be implemented at the UE or is not acceptable to the UE. For example UE1 300a is configured to generate and send an accept message or reject message with respect to whether the substitute training UE configuration is able to be implemented at UE1 300a or is acceptable to UE1 300a at 721 and UE2 300b is configured to generate an accept message or reject message with respect to whether the substitute training UE configuration is able to be implemented at UE2 300b or is acceptable to UE2 300b at 723.

The FL aggregator 700 can then optionally (in response to receiving from at least one of the first or second UEs a reject message) generate and send to the selected first and second UEs a new substitute training UE configuration as shown in FIG. 7 at 725.

These first UE and second UE selection and configuration steps can repeat until the configuration is accepted. Then the communications or signalling associated with local model training as described above can be implemented.

Thus having configured the first UE, UE1 300a, and second UE, UE2 300b such that the second UE is a substitute training UE for the first UE, UE1 300a, an iteration of FL can be performed with the first UE, UE1 300a, as shown in FIG. 7 at 731.

The iteration of FL training with the first UE, UE1 300a at 731, can in some embodiments comprise the FL aggregator 700 performing broadcasting of a global model and training configuration as shown in FIG. 7 at 733.

Then each of the selected first UEs are configured to perform local model training. For example UE1 300a performs local model training as shown in FIG. 7 at 735.

Having implemented local training, the K selected first UEs are then configured to report the result of the local model training. For example with respect to UE1 300a sends the local training result to the FL aggregator 700 in FIG. 7 at 737. (Although not shown other selected first UEs, for example UE3 300c, are configured to report the result of their local training). The local training result sent by each of the selected first UEs may be values of the parameters of the local model when local training has been completed, updates of the parameters of the local model, or gradients of the parameters of the local model. The updates of the parameters of the local model can be the difference between the original values of the parameters and the final values of the parameters after local training is complete.

Furthermore the FL aggregator 700 is then configured to perform aggregation of the received local training results to obtain aggregated training results for the global model as shown in FIG. 7 at 739.

In some embodiments the second UE is configured to perform local model training upon determination of unavailability of first UE for local model training. In some embodiments the second UE (also known as the substitute UE or secondary UE) is configured to perform the local model training based on receiving a request to perform local model training (or model training transfer request). The request to perform local model training (otherwise referred to herein as a local model training request) includes an indication of the unavailability of the first UE, UE1 300a to be able to perform local model training). The local model training request is received by the second UE from the selected first UE, UE1 300a, or the FL aggregator 700.

Thus for example as shown in FIG. 7 the first UE, UE1 300a, is configured to determine that the first UE, UE1 300a is experiencing a local training unavailability event as shown in FIG. 7 at 741. In other words, the first UE, UE1 300a determines that it cannot perform local model training for example, based on a lack of computation or power resources available at the first UE.

The first UE, UE1 300a, is then configured to generate and send to the second UE, UE2 300b, a request to transfer local model training (otherwise referred to as a model training transfer request) as shown in FIG. 7 at 743. The local model training request (or model training transfer request) in some embodiments may further contain information indicating the cause for transferring local model training to the second UE or substitute training UE and/or a time duration in which the local model training is to be performed at the second UE.

The second UE, UE2 300b, can then be configured to generate and send to the first UE a local training accept message (e.g., a suitable acknowledgement or response message) in response accepting to perform local model training and send the local training accept message as shown in FIG. 7 at 745.

In some embodiments the first UE, for example UE1 300a, is configured to send an indication on its unavailability directly to the FL aggregator 700 and the FL aggregator 700 is configured to either forward this indication to the second UE or explicitly activate the second UE, UE2 300b, for local training of a local model (by generating a suitable trigger message, a local model training request or a model training transfer request) and sending the trigger message, a local model training request or model training transfer request to the second UE).

In such embodiments the second UE, UE2 300b is then configured to send to the FL aggregator 700a local model training accept message (e.g., a suitable acknowledgement or response message) in response to accepting to perform local model training.

The first UE, UE1 300a, is then configured to stop monitoring for a global model and training configuration sent by the FL aggregator 700 as shown in FIG. 7 at 747 and the second UE, UE2 300b, is configured to start monitoring for the global model and training configuration sent by the FL aggregator 700 as shown in FIG. 7 at 749.

This in effect enables the second UE, UE2 300b to participate in an iteration of FL as shown in FIG. 7 at 751.

In the iteration of FL (otherwise referred to as a FL iteration), the FL aggregator 700 can, in some embodiments, be configured to perform broadcasting the global model and training configuration as shown in FIG. 7 at 753. In other words, the FL aggregator 700 can he global model and training configuration to UE1 300a and UE2 300b.

Then each of the ‘active’ second UEs are configured to perform local model training (i.e., local training of a local model using a local dataset). For example UE2 300b perform local model training as shown in FIG. 7 at 755.

Having performed local model training, the ‘active’ second UEs are then configured to report their local training results back to the FL aggregator 700. For example with respect to UE2 300b the local training result is sent to the FL aggregator 700 in FIG. 7 at 757 by for example, sending a message comprising the local training result.

In embodiments where the second UE (e.g. UE2 300b) is configured to perform local model training based on receiving a local training activation request (comprising an indication of the unavailability of the first UE (e.g., UE1 300a) to be able to perform local model training) from the selected first UE or the FL aggregator 700, the second UE (e.g. UE2 300b) may send in addition to the local training result, an indication that the second UE is participating in FL (i.e., an indication that the second UE is a substitute training UE for the first UE) to the FL aggregator 700 so that the FL aggregator 700 does not discard the local training result sent by the second UE. The local training result and the indication may be included in a message sent by the second UE (e.g., UE2 300b) to the FL aggregator 700. The indication that the second UE is participating in FL to the FL aggregator 700 is otherwise referred to herein as a training handover indication and is shown in FIG. 7 at 757.

Furthermore the FL aggregator 700 is then configured to perform aggregation of the local training results received from the active second UE, UE2 300b, and other first and second UEs as shown in FIG. 7 at 759.

The implementations and embodiments discussed above thus aim to provide interruption-free model training using federated learning even when one or more distributed nodes (e.g., training UEs) fail to perform local training (e.g., when a first UE is temporarily unavailable, the second substitute UE can act as a training UE until the first UE is back online again). Also, it minimizes signalling and computations associated with reselection of training UEs (UEs which participate in model training using FL) when one or more training UE(s) fails to perform local training. This is particularly beneficial in those scenarios where the unavailability of a training UE (on and off availability) is frequent (which otherwise triggers frequent reselection of training UEs for model training using FL at the FL aggregator).

In addition, the above embodiments can provide load balancing in terms of local model training in order to avoid exploitation of a UE or small group of UEs in local model training using federated learning. The embodiments thus enable a local model training to be temporarily transferred to another UE so that the ‘overemployed’ or ‘overused’ UEs are not always performing local model training.

The FL aggregator 500, 600, 700 of the present disclosure described herein may be implemented in an AF of the 5GS shown in FIG. 1. Alternatively, the FL aggregator 500, 600, 700 of the present disclosure described herein may be implemented in a Network Data Analytics Function of a 5GC, an Operations, Administration and Maintenance entity of a 5GS, or any network function (NF) of a 5GC, such as the AMF, the SMF, the PCF, etc.

It should be understood that the apparatuses may comprise or be coupled to other units or modules etc., such as radio parts or radio heads, used in or for transmission and/or reception. Although the apparatuses have been described as one entity, different modules and memory may be implemented in one or more physical or logical entities.

It is noted that whilst some embodiments have been described in relation to 5G systems, similar principles can be applied in relation to other networks and communication systems. Therefore, although certain embodiments were described above by way of example with reference to certain example architectures for radio access and core networks, radio access technologies and standards, embodiments may be applied to any other suitable forms of communication systems that implement other radio access technologies than those illustrated and described herein.

It is also noted herein that while the above describes example embodiments, there are several variations and modifications which may be made to the disclosed solution without departing from the scope of the present invention.

In general, the various embodiments, the FL aggregator may be implemented in hardware or special purpose circuitry, software, logic or any combination thereof. Some aspects of the disclosure may be implemented in hardware, while other aspects may be implemented in firmware or software which may be executed by a controller, microprocessor or other computing device, although the disclosure is not limited thereto. While various aspects of the disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.”

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The embodiments of this disclosure may be implemented by computer software executable by a data processor of the mobile device, such as in the processor entity, or by hardware, or by a combination of software and hardware. Computer software or program, also called program product, including software routines, applets and/or macros, may be stored in any apparatus-readable data storage medium and they comprise program instructions to perform particular tasks. A computer program product may comprise one or more computer-executable components which, when the program is run, are configured to carry out embodiments. The one or more computer-executable components may be at least one software code or portions of it.

Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD. The physical media is a non-transitory media.

The memory may be of any type suitable to the local technical environment and may be implemented using any suitable data storage technology, such as semiconductor based memory devices, magnetic memory devices and systems, optical memory devices and systems, fixed memory and removable memory. The data processors may be of any type suitable to the local technical environment, and may comprise one or more of general purpose computers, special purpose computers, microprocessors, digital signal processors (DSPs), application specific integrated circuits (ASIC), FPGA, gate level circuits and processors based on multi core processor architecture, as non-limiting examples.

Embodiments of the disclosure may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The scope of protection sought for various embodiments of the disclosure is set out by the independent claims. The embodiments and features, if any, described in this specification that do not fall under the scope of the independent claims are to be interpreted as examples useful for understanding various embodiments of the disclosure.

The foregoing description has provided by way of non-limiting examples a full and informative description of the exemplary embodiment of this disclosure. However, various modifications and adaptations may become apparent to those skilled in the relevant arts in view of the foregoing description, when read in conjunction with the accompanying drawings and the appended claims. However, all such and similar modifications of the teachings of this disclosure will still fall within the scope of this invention as defined in the appended claims. Indeed, there is a further embodiment comprising a combination of one or more embodiments with any of the other embodiments previously discussed.

1. An apparatus to for training a model using federated learning, the apparatus comprising:
at least one processor; and
at least one memory storing instructions which, when executed by the at least one processor cause the apparatus to perform operations, the operations comprising:
selecting a plurality of further apparatus for training a local model;
further selecting a first substitute apparatus for a first further apparatus of the plurality of further apparatus; and
configuring each of the plurality of further apparatus for training the local model and configuring the first substitute apparatus for the first further apparatus of the plurality of further apparatus for training the local model;
receiving a local training result from a second further apparatus of the plurality of further apparatus;
receiving a a local training result from the first substitute apparatus for the first further apparatus; and
combining the local training result from the one or more of the plurality of further apparatus and the local training result from the first substitute apparatus of the first further apparatus to generate aggregated training results for the model.

2. The apparatus as claimed in claim 1, wherein the further selecting the substitute apparatus for the first further apparatus comprises further selecting the substitute apparatus based on information indicating at least one of:
a similarity in a data distribution of data of a local dataset for the first further apparatus and a data distribution of data of a local dataset for the substitute apparatus;
a location of the first further apparatus;
a location of the substitute apparatus;
a proximity between the first further apparatus and the substitute apparatus;
a mobility pattern of the substitute apparatus relative to the first further apparatus;
a quality of communications on a sidelink between the first further apparatus and the substitute apparatus;
at least one characteristic of a wireless link between the first further apparatus and a base station of a radio access network.

3. The apparatus as claimed in claim 1, wherein the operations further comprise receiving, from the first further apparatus, information identifying one or more candidate substitute apparatus, wherein the selecting the substitute apparatus for the first further apparatus comprises selecting one of the one or more candidate substitute apparatus as the substitute apparatus based on the information identifying the one or more candidate substitute identified apparatus.

4. The apparatus as claimed in claim 1, wherein the operations further comprise generating and sending a federated learning (FL) report configuration to each of the plurality of further apparatus, wherein the FL report configuration comprises an indicator configured to cause generation and sending of a FL report comprising information identifying one or more candidate substitute apparatus.

5. The apparatus as claimed in claim 1, wherein the configuring each of the plurality further apparatus for training the local model and the configuring the substitute apparatus for training the local model comprises generating a substitute training configuration for each of the plurality of further apparatus and the substitute apparatus, the substitute training configuration comprising at least one of:
a first further apparatus identifier configured to uniquely identify the first further apparatus;
a substitute apparatus identifier configured to uniquely identify the substitute apparatus;
a condition identifier configured to identify a trigger condition where the first further apparatus is unable to train the local model and which causes the substitute apparatus to perform local model training to train the local model of the substitute apparatus.

6. The apparatus as claimed in claim 5, wherein the trigger condition comprises at least one of:
a minimum quality of a wireless link between the first further apparatus and a base station of a radio access network;
a minimum computation resource availability at the first further apparatus;
a minimum power resource availability at the first further apparatus;
a minimum security level associated with a local dataset of the first further apparatus; and
a minimum integrity level associated with a local dataset of the first further apparatus.

7. The apparatus as claimed in claim 1, wherein the operations further comprise receiving from the substitute apparatus an indication that the substitute apparatus is a substitute apparatus for the first further apparatus.

8. The apparatus as claimed in claim 1, wherein the operations further comprise:
receiving from the first further apparatus an indication that the first further apparatus is unable to train the local model; and
sending a request to the substitute apparatus to cause the substitute apparatus to perform local model training.

9. The apparatus as claimed in claim 8, wherein the request comprises at least one of:
an indicator of the cause of the first further apparatus being unable to train the local model; and
a time indicator indicating the time by which the substitute apparatus is to perform the local model training.

10. The apparatus as claimed in claim 1, wherein the apparatus is one of:
a base station of a radio access network, wherein each of the plurality of further apparatus and the substitute apparatus are user equipment;
a Network Data Analytics entity of the communication system, wherein each of the plurality of further apparatus and the substitute apparatus are distributed Network Data Analytics entities of the communication system; or
an Operations, Administration and Maintenance entity of the communication system, wherein each of the plurality of further apparatus and the substitute apparatus are base stations.

11. A first apparatus for training a local model during federated learning, the apparatus comprising:
at least one processor; and
at least one memory storing instructions which, when executed by the at least one processor cause the apparatus to perform operations, the operations comprising:
receiving substitute training configuration from a second apparatus configured to train a local model, the substitute training configuration comprising:
an apparatus identifier configured to uniquely identify the first apparatus for training the local model; and
a second apparatus identifier configured to uniquely identify a substitute apparatus for the first apparatus; and
a condition identifier configured to identify a trigger condition where the first apparatus is unable to train the local model and which causes the substitute apparatus to perform local model training; and
training the local model and transmitting a local training result to the apparatus, or determining that the first apparatus is unable to train the local model based on the trigger condition and transmitting a local model training request to one of the second apparatus or the substitute apparatus to cause the one of the second apparatus or the substitute apparatus to perform local model training.

12. The first apparatus as claimed in claim 11, wherein the operations further comprise generating information indicating at least one candidate substitute apparatus based on information indicating at least one of:
a data distribution of the data in local datasets at the apparatus and a data distribution of the data in the local datasets at the candidate substitute apparatus;
a data distribution of local data for the apparatus and the candidate substitute apparatus;
a range of the data in local datasets at the apparatus and the candidate substitute apparatus;
an interquartile range for the data in local datasets at the apparatus and the candidate substitute apparatus;
a standard deviation for the data in local datasets at the apparatus and the candidate substitute apparatus;
a variance of the data in local datasets at the apparatus and the candidate substitute apparatus;
a proximity between the apparatus and the candidate substitute apparatus; and
a mobility pattern between the apparatus and the candidate substitute apparatus.

13. The first apparatus as claimed in claim 12, wherein the operations further comprise receiving a request from the further apparatus to generate the information indicating the at least one candidate substitute apparatus.

14. The first apparatus as claimed in claim 12, wherein the trigger condition comprises at least one of a minimum quality of a wireless link between the first apparatus and a base station of a radio access network; a minimum computation resource availability at the first apparatus; a minimum power resource availability at the first apparatus; a minimum security level associated with a local dataset of the second apparatus, and a minimum integrity level associated with a local dataset of the second apparatus.

15. The first apparatus as claimed in claim 11, wherein the local model training request comprises:
an indicator of a cause of the first apparatus being unable to train the local model; and
a time indicator indicating the time by which the substitute apparatus is to perform local model training.

16. The first apparatus as claimed in claim 11, wherein the operations further comprise generating one of an accept message when the substitute training configuration is acceptable to the first apparatus and a reject message when the substitute training configuration is unacceptable to the first apparatus, and sending to the second apparatus, the one of the accept message and reject message to cause the second apparatus to re-select or re-configure the substitute training UE configuration.

17. The first apparatus as claimed in claim 11, wherein the first apparatus is a first user equipment, wherein the substitute apparatus is a second user equipment and the second apparatus is a base station of a radio access network.

18. The first apparatus as claimed in claim 11, wherein the first apparatus is a distributed network data analytics entity, wherein the second apparatus is a centralized Network Data Analytics entity and the substitute apparatus is a distributed Network Data Analytics entity.

19. The first apparatus as claimed in claim 11, wherein the first apparatus is a first base station of a radio access network, wherein the second apparatus is an Operations, Administration and Maintenance entity, and the substitute apparatus is a second base station of the radio access network.

20. A first apparatus for training a local model during federated learning, the apparatus comprising:
at least one processor; and
at least one memory storing instructions which, when executed by the at least one processor cause the apparatus to perform operations, the operations comprising:
receiving substitute training UE configuration from a second apparatus configured to train a local model,
the substitute configuration comprising:
an apparatus identifier configured to uniquely identify a third apparatus as an apparatus for training the local model using a local dataset;
a substitute apparatus identifier configured to uniquely identify the first apparatus as a substitute training apparatus for the third apparatus; and
a condition identifier configured to identify a trigger condition where the third apparatus is unable to train the local model and which causes the first apparatus to train the local model; and
receiving, from the third apparatus or the second apparatus, a local model training request to perform local model training;
in response to receiving the local model training request, training a local model using a local dataset to generate a local training result and transmitting the local training result to the second apparatus.

21. The first apparatus as claimed in claim 20, wherein the local model training request comprise at least one of:
an indicator identifying the condition causing the third apparatus to be unable to train the local model; and
a time indicator indicating the time by which first apparatus is to perform local model training.

22. The first apparatus as claimed in claim 20, wherein the operations further comprise generating one of an accept message when the substitute training configuration is acceptable to the first apparatus and a reject message when the substitute training configuration is unacceptable to the first apparatus, and sending to the second apparatus, the one of the accept message and reject message to cause the second apparatus to re-select or re-configure the substitute training configuration.

23. The first apparatus as claimed in claim 20, wherein the operations further comprise transmitting an indication that the first apparatus is the substitute training apparatus for the third apparatus.

24. The first apparatus as claimed in claim 20, wherein the first apparatus is a first user equipment, wherein the third apparatus is a second user equipment and the second apparatus is abase station of a radio access network.

25. The first apparatus as claimed in claim 20, wherein the first apparatus is a distributed network data analytics entity, wherein the second apparatus is a centralized Network Data Analytics entity and the third apparatus is a distributed Network Data Analytics entity.

26. The first apparatus as claimed in claim 20, wherein the first apparatus may be a first base station of a radio access network, wherein the second apparatus is an Operations, Administration and Maintenance entity, and the third apparatus is a second base station of the radio access network.

27-29. (canceled)
